(19) United States
(12) Patent Application Publication
(10) Pub. No.: US 2025/0244581 A1
(43) Pub. Date: Jul. 31, 2025

(54) LIGHT ENGINE MOUNTING SYSTEMS FOR AUGMENTED REALITY OR VIRTUAL REALITY DISPLAYS

(71) Applicant: SNAP INC., Santa Monica, CA (US)

(72) Inventor: Stephen John Rogers, Didcot (GB)

(21) Appl. No.: 18/853,984

(22) PCT Filed: Apr. 3, 2023
(86) PCT No.: PCT/EP2023/058633

§ 371 Date: Oct. 3, 2024

(30) Foreign Application Priority Data
Apr. 8, 2022 (EP) 22167465.8

(51) Int. Cl. G02B 27/01; G02B 7/00

(52) U.S. Cl. CPC G02B 27/0149; G02B 7/004; G02B 2027/0134; G02B 2027/0154

(57) ABSTRACT

A light engine mounting system for an AR or VR display. A light engine is housed within an adjustable mount body and projects light along a first direction with respect to the adjustable mount body. A mount housing has a mount housing axis and comprises a cavity configured to receive the adjustable mount body and a first aperture through an exterior of the mount housing that opens into the cavity such that the light engine may project light through the mount housing via the first aperture. The first aperture is spaced from the cavity along the direction of the mount housing axis. The adjustable mount body and the cavity enable the adjustable mount body to rotate within the cavity around a first rotation axis, such that an angle of the first direction can be changed with respect to the mount housing axis.

### FIELD OF THE INVENTION

The invention relates to a light engine mounting system for an augmented reality or virtual reality display and methods for adjusting it. In particular, the invention relates to a light engine mounting system that can simplify the monocular alignment of a light engine with a waveguide combiner and the binocular alignment of a light-engine/waveguide combiner combination with another one.

### BACKGROUND OF THE INVENTION

Augmented Reality (AR) displays typically comprise a see-through display screen called a waveguide combiner that combines light from the real world surrounding a user and from a projector coupled to an electronic interface in order to “imprint” virtual graphic information onto their immediate environment and thus enhance their immersive visual experience. This virtual graphic information may be text, symbols, images, videos or drawings of any type.

To satisfy the general population's desire for portability and comfort, AR displays are to exhibit a form factor akin to that of a conventional pair of glasses by accommodating one or more waveguide combiners as eyepieces and one or more projectors as providers of virtual graphic information. Furthermore, optionally encapsulating the one or more waveguide combiners in between correction lenses makes AR accessible to visually impaired people.

The role of a waveguide combiner in an AR display is to efficiently channel an image-bearing light from a projector to the eye of viewer. The light enters through an input region, travels via total internal reflection within the waveguide to an output region, which directs the light to a user's eye. The waveguide combiner must be thus optically aligned with its associated projector so as to receive the image-bearing light: this is called monocular alignment. Monocular alignment is usually achieved by carefully spatially arranging the projector, its optical assembly and the waveguide combiner, such that the boresight (optical axis) of the projected light is incident on a desired point of the input region of the waveguide combiner-usually the centre point. It will be appreciated that the optical assembly of the projector may be internal and/or external to the projector and its end (distal to the light source of the projector) is located above and close to the input region of the waveguide combiner so as to avoid the spread of angles of the rays of the image-bearing light incident on the input region and output said light collimated.

Implementing the monocular alignment of the waveguide combiner with the projector during the manufacturing requires to spatially arrange them relative to each other with high precision, leaving a small tolerance for error. Accordingly, there is a need to ease the implementation of the monocular alignment of the waveguide combiner with the projector and to increase its related tolerance for error.

Additionally, when considering a right-hand projector/waveguide combiner combination and a left-hand projector/waveguide combiner combination integrated into an AR glasses pair (in which their respective waveguide combiners play the role of one of the left and right eyepieces and are to occupy a given position in the AR glasses pair frame), there is a need for accurate binocular alignment between the left-hand and right-hand projector/waveguide combiner combinations.

An object of the present invention is to address these needs.

### SUMMARY OF THE INVENTION

According to a first aspect of the invention, there is provided a light engine mounting system for an augmented reality or virtual reality display, comprising:
a light engine housed within an adjustable mount body, the light engine being configured to project light along a first direction with respect to the adjustable mount body; and
a mount housing having a mount housing axis, the mount housing comprising a cavity configured to receive the adjustable mount body and a first aperture through an exterior of the mount housing that opens into the cavity such that the light engine may project light through the mount housing via the first aperture, the first aperture being spaced from the cavity along the direction of the mount housing axis;
wherein the adjustable mount body and the cavity of the mount housing are shaped so as to enable the adjustable mount body to at least partially rotate within the cavity of the mount housing around at least a first rotation axis, such that the angle of the first direction may be changed with respect to the mount housing axis.

In this way, by at least partially rotating the adjustable mount body within the mount housing cavity around at least a first rotation axis, the first direction i.e. the propagation direction of the image-bearing light (emitted by the light engine of the light engine mounting system) can be adjusted relative to the mount housing axis so as to target a given point in space that may belong to either a line (considering a single rotation axis) or a plane (considering two rotation axes). Accordingly, the first direction can be changed relative to the mount housing axis to some extent, which allows for increasing the range of available propagation directions of the image-bearing light emitted by the light engine and thus the range of available angles of the first direction relative to the mount housing axis. The range of available angles of the first direction relative to the mount housing axis must maintain the integrity of the image-bearing light beam emitted by the light engine, otherwise at least some of the virtual graphic information encoded in the image-bearing light would be lost. This requirement has a direct effect on the design of the light engine, the adjustable mount body and the mount housing: the image-bearing light beam emitted by the light engine should be able to escape from the light-engine and the mount housing unaltered. The image-bearing light is first generated by a light source (located within the light engine), then steered and collimated through the optical assembly of the light engine until exiting said light engine via an exit point. From the exit point, the image-bearing light is next conveyed along a first direction relative to the mount body through the mount housing cavity and the first aperture to a target point. The angle of the first direction relative to the mount housing axis is zero when the mount housing axis and the first direction are parallel to each other. The angle of the first direction relative to the mount housing axis is different to zero when the mount housing axis and the first direction are not parallel to each other and consequently intersect. The larger the maximum angle of the first direction relative to the mount housing axis (assuming the image-bearing light remains unaltered from the exit point to the target point), the more the first direction can be changed with respect to the mount housing axis, the more points in space can be targeted.

As mentioned, the adjustable mount body is able to at least partially rotate within the cavity of the mount housing. Typically, the adjustable mount body will be able to only partially rotate within the cavity of the mount housing. Although it is envisaged that some mount bodies may be capable of full rotation, e.g. a spherical mount body in a spherical cavity.

In preferred embodiments, the adjustable mount body and the cavity of the mount housing are shaped so as to enable the adjustable mount body to at least partially rotate within the cavity of the mount housing around a second rotation axis such that the angle of the first direction may be changed with respect to the mount housing axis, the second rotation axis being different from the first rotation axis and preferably being perpendicular to the first rotation axis.

Thus, by at least partially rotating the adjustable mount body within the mount housing cavity around a second rotation axis, the first direction i.e. the propagation direction of the image-bearing light can be adjusted relative to the mount housing axis so as to target a given point in space that belongs to a plane as two rotation axes are now involved. Consequently, the range of available angles of the first direction relative to the mount housing axis increases further by going from a single rotation axis to two rotation axes. When the first and second rotation axes are perpendicular to one another, one of the first and second rotation axes relates to the yaw adjustment of the adjustable mount body while the other one of the first and second rotation axes to its pitch adjustment.

In preferred embodiments, the mount housing cavity extends from the first aperture through the mount housing to a second aperture through an exterior of the mount housing, wherein preferably the cavity extends between the first and second apertures along the direction of the mount housing axis, and further preferably wherein the mount housing comprises a front face having the first aperture and a rear face having the second aperture, the front and rear faces preferably being parallel to each other, and the cavity extending along the direction normal to both the front and rear faces.

Consequently, the mount housing cavity extends from the first aperture to the second aperture, preferably along the direction of the mount housing axis. Preferably, the first and second apertures belong to the front and rear faces, respectively.

The first and second faces may preferably be parallel to one another and the mount housing cavity may extend preferentially along the direction normal to both front and rear faces, which then corresponds to the direction of the mount housing axis. In this specific case, when the angle of the first direction relative to the mount housing axis is zero, the first direction is the direction normal to the front and rear faces.

If the front and rear faces are not parallel, the cavity may adopt for instance a L-shaped form. In preferred embodiments, the first rotation axis and, if provided, the second rotation axis are both perpendicular to the mount housing axis and the axes intersect at a single point within the mount housing.

Consequently, when the direction of the mount housing axis corresponds to the direction normal to the front and rear faces, the first rotation axis and, if provided, the second rotation axis are perpendicular to the direction normal to the front and rear faces

The single point within the mount housing may be the barycentre of the apparatus corresponding to the light engine housed in the adjustable mount body such that the at least partial rotation of the adjustable mount body within the mount housing cavity around the first rotation axis and, if provided, the second rotation axis maintains the barycentre at the same place.

In particularly preferred embodiments, the adjustable mount body and the cavity of the mount housing are shaped so as to enable the adjustable mount body to at least partially rotate within the mount housing cavity around the mount housing axis.

Accordingly, the at least partial rotation of the adjustable mount body within the mount housing cavity around the mount housing axis allows for adjusting the roll i.e. how the image (represented by the image-bearing light) is rotated on the image plane. The image plane is the plane (perpendicular to the propagation direction of the image-bearing light and located opposite the source of the image-bearing light i.e. the light engine) that receives the image encoded in the image-bearing light. The at least partial rotation of the adjustable mount body around the first rotation axis and/or the second rotation axis controls the position of the image on the image plane.

In particularly preferred embodiments, the adjustable mount body and the cavity of the mount housing are shaped so as to enable the adjustable mount body to be translatable within the mount housing cavity along the direction of the mount housing axis.

Thus, the translation of the adjustable mount body within the mount housing cavity along the direction of the mount housing axis is to adjust the distance between the exit point of the image-bearing light from the light engine and the target point such that this distance equals the focal distance of the optical assembly of the light engine. When achieved, the image is in focus at the target point and the sharpness of the image at the target point is at its best. The translation in question is to be of limited extent so as to maintain the initial amount of virtual graphic information contained in the image-bearing light and to keep said image-bearing light collimated.

In preferred embodiments, the mount housing further comprises:
a sidewall;
a slot having a height and located in the sidewall such that the slot extends along the sidewall along the direction of the mount housing axis, the slot being in communication with the mount housing cavity; and
an adjustable clamping mechanism to adjust the height of the slot, whereby adjustment of the height of the slot allows the adjustable mount body to be selectively clamped in position within the cavity.

In this way, the adjustable clamping mechanism of the mount housing controls the height of the slot and thus the size of the mount housing cavity, which determines the possibility for the adjustable mount body to either remain rotatable and translatable within the mount housing cavity, or be locked in a position within the mount housing cavity. If the size of the mount housing cavity is sufficiently greater than the size of the adjustable mount body, then the adjustable mount body remains rotatable and translatable within the mount housing cavity. If the size of the mount housing cavity is only marginally greater than, or substantially equal to, the size of the adjustable mount body, the adjustable mount body is locked in a position. When the adjustable clamping mechanism locks the adjustable mount body in a position, it sets the angle of the first direction relative to the mount housing axis to a given value and thus selects the propagation direction of the image-bearing light.

Preferably, the adjustable clamping mechanism comprises:
a first hole through the sidewall of the mount housing along a direction other than parallel to the slot so as to have first and second portions of the first hole aligned and separated by the slot; and
a shaft member extending through the first hole for engaging parts of the sidewall either side of the slot and urging said parts of the sidewall together so as to adjust the height of the slot.

Thus, the shaft member controls the height of the slot by engaging each of the two parts of the sidewall to a given extent either side of the slot via the first and second portions of the first hole. The shaft member may take many forms, provided it is capable of engaging the two parts of the sidewall either side of the slot. For example, the shaft may have a head on one side greater than the size of the first hole, and may be threaded towards an opposing side, such that a nut may be rotated around the shaft to change the size of the slot.

However, preferably, the first and second portions of the first hole are non-threaded and threaded respectively;
the shaft member, preferably being a partially-threaded screw, has first and second portions which are non-threaded and threaded, respectively, and having a first end, preferably a screw head, and a second end, preferably a screw tip, the first end being exposed and having an interface to enable its rotation; and
the first portion of the first hole receives the first shaft member portion and the second portion of the first hole receives at least a part of the second shaft member portion.

In this way, the first portion of the shaft member is not mechanically engaged with the first portion of the first hole while the second portion of the shaft member is mechanically engaged with the second portion of the first hole via their respective threads such that the rotation of the shaft member allows for translating only the part of the sidewall containing the second portion of the first hole in two opposite directions depending on the direction of the rotation of the shaft member i.e. clockwise or anticlockwise and thus for controlling the height of the slot.

Additionally, the shaft member may be for instance a rod or bar, or preferably a partially-threaded screw. Furthermore, the first end of the shaft member may have a size that is larger than the size of the first hole, such that the shaft member can rotate within the first hole and cannot translate into the first hole, said first end being held by an exterior of the mount housing. Consequently, a compressive force is applied by the first end of the shaft member on an exterior of the mount housing holding the first end of the shaft member, while rotating the shaft member in, for example, a clockwise direction. Such action brings the first and second portions of the first hole closer to each other and thus controls the height of the slot and the size of the mount housing cavity. Compressive force is released when rotating the shaft member, for example, anticlockwise. Such action brings the first and second portions of the first hole further apart from each other and thus controls the height of the slot and the size of the mount housing cavity. The adjustable clamping mechanism allows for reversibly switching the adjustable mount body from a rotatable/translatable state to a fixed state.

The adjustable clamping mechanism may comprise a rebate (located in the sidewall) to receive the first end of the shaft member in order to place said first end below the level of an exterior of the mount housing, in other words to recess said first end in the sidewall of the mount housing. This may prove useful if the claimed light engine mounting system is to be inserted into a cavity, as it prevents the first end from altering the profile of the mount housing: without a rebate, said cavity must have a more complex form to accommodate the light engine mounting system.

While the combination of a hole and shaft is preferred, alternatively, the adjustable clamping mechanism may comprise:
a band having an adjustable length, the band being placed around the mount housing axis such that adjustment of the length of the band adjusts the height of the slot.

In this way, the height of the slot is controlled by adjusting the amount of length of the band being around the mount housing, more precisely around the mount housing axis as the first and second apertures should not be occluded by the band, otherwise the propagation of the image-bearing light would be at best hindered or at worst stopped by the band.

Preferably, the adjustable clamping mechanism comprises:
the band having a length, a first end, a second end and a plurality of periodically-spaced grooves along the length of the band;
a clamping device affixed to the band first end, comprising:
   a slit through which a portion of the band including the band second end passes; and
   a threaded shaft whose one end is exposed and having an interface to enable its rotation, the thread of the threaded shaft being engaged with a portion of the plurality of grooves of the band, whereby the rotation of the threaded shaft controls the extent of the portion of the band between the band first end and the slit.

Thus, rotating the threaded shaft clockwise or anticlockwise reversibly increases or decreases the length of the band around the mount housing (while the front and rear faces are not occluded by the band) and thus reversibly controls the height of the slot and the size of the mount housing cavity. The adjustable clamping mechanism allows for reversibly switching the adjustable mount body from a rotatable/translatable state to a fixed state. The threaded shaft may be a screw and the clamping device allows for the rotation of the threaded shaft via the end having an interface to enable its rotation, while preventing the threaded shaft from translating.

The external corners of the mount housing may be rounded off (over a narrow distance) to aid the movement of band as it is tightened or loosened around the mount housing. The provision of rounded external corners over a narrow distance a little wider than the band width can prevent lateral movement of the band along the length of the mount housing.

In preferred embodiments, the adjustable mount body has one or more curved external walls, the one or more curved external walls engaging one or more internal walls of the mount housing defined by the mount housing cavity, the one or more curved external walls allowing the adjustable mount body to be at least partially rotated while maintaining engagement between the one or more curved external walls and the one or more internal walls, wherein preferably the adjustable mount body has a generally partially spherical or bulbous portion defined by the one or more curved external walls.

Consequently, the at least partial rotation of the adjustable mount body within the mount housing cavity around the or each rotation axis (i.e. the first rotation axis, the second rotation axis and the mount housing axis) is facilitated by having the one or more external walls of the adjustable rotatable mount curved and engaged with the one or more internal walls of the mount housing defining the mount housing cavity.

Additionally, the one or more curved external walls of the adjustable mount body also makes the translation of the adjustable mount body within the mount housing cavity along the direction of the mount housing axis easier.

Having the one or more internal walls of the mount housing curved so as to conform to and fit into the one or more curved external walls of the adjustable mount body increases the surface of contact between the adjustable mount body and the mount housing cavity, which allows a better control for adjusting the adjustable mount body within the mount housing cavity. Controlling the at least partial rotation and/or the translation of the adjustable mount body within the mount housing cavity indeed implies setting a compromise between having the adjustable mount body sufficiently held by the mount housing cavity and having the adjustable mount body sufficiently free from the mount housing cavity to undergo said rotation and/or said translation.

The adjustable mount body and the mount housing may be, for instance, a ball and socket type fitting or alternatively may be a ball or an ovoid within a cylinder.

In preferred embodiments, the mount housing cavity is substantially cylindrical.

Thus, the cylindrical shape of the mount housing cavity facilitates the adjustment of the adjustable mount body within the mount housing cavity when the adjustable mount body undergoes any at least partial rotation around the or each rotation axis and/or translation within the mount housing cavity.

In preferred embodiments, the adjustable mount body further comprises an extended portion, said extended portion being arranged to extend through the second aperture, the extended portion being configured to be engaged to cause the adjustable mount body to at least partially rotate within the mount housing cavity around the or each rotation axis, and preferably to translate the adjustable mount body within the mount housing cavity along the direction of the mount housing axis.

Consequently, the extended portion allows for at least partially rotating the adjustable mount body within the mount housing cavity around the or each rotation axis and translating it within the mount housing cavity preferentially along the direction of the mount housing axis. A projecting arm may control the extended portion and accordingly the adjustment of the adjustable mount body within the mount housing cavity. The projecting arm may be commanded by a human operator or a robotic arm under computer control, the latter promoting reproducibility.

In preferred embodiments, the mount housing further comprises at least one second hole, the second hole extending through the exterior of the mount housing and opening into the cavity such that the mount housing cavity is accessible via the at least one second hole, wherein the or each second hole is preferably arranged to allow the adjustable mount body to be permanently fixed in place in the cavity by means of an adhesive injected through said second hole.

Accordingly, the presence of the at least one second hole allows for providing adhesive into the mount housing cavity so as to apply it in between the one or more external walls of the adjustable mount body and the one or more internal walls of the mount housing defining the mount housing cavity in order to permanently fix the adjustable mount body within the mount housing cavity in a desired orientation, and thus set the first direction to a given direction and the angle of the first direction relative to the mount housing axis to a given value.

According to a second aspect of the present invention, there is provided an augmented reality or virtual reality display, comprising:
a first light engine mounting system according to the first aspect of the invention configured to provide a first image-bearing light representing a first image;
a frame; and
a first waveguide combiner being fixed within the frame and comprising at least one waveguide substrate, the at least one waveguide substrate comprising a first input region and a first output region to couple the first image-bearing light into and out of the at least one waveguide substrate, respectively, the first input region having a perimeter;
wherein the adjustable mount body of the first light engine mounting system is able to at least partially rotate within the mount housing cavity around at least its first rotation axis in order to change where the first image-bearing light falls relative to the perimeter of the first input region of the at least one waveguide substrate, such that the first image-bearing light may be coupled into the at least one waveguide substrate, then steered towards the first output region and coupled out of the at least one waveguide substrate.

In this way, by partially rotating the adjustable mount body of the first light engine mounting system within its mount housing cavity around at least its first rotation axis, it is possible to modify the first direction of the light engine such that the direction of propagation of the first image-bearing light (emitted by the light engine of the first light engine mounting system) may be changed relative to the perimeter of the input region of the at least one waveguide substrate of the first waveguide combiner, e.g. to ensure that the first image-bearing light falls within the perimeter of the input region of the at least one waveguide substrate of the first waveguide combiner. For example, the first image-bearing light may initially fall outside said perimeter when the mounting system is installed relative to the waveguide combiner. Then, by modifying the first direction of the light engine of the first light engine mounting system relative to the mount housing axis, the whole beam of the first image-bearing light may fall first partially within said perimeter. Subsequently, the whole beam may fully fall within said perimeter such that the first image-bearing light is fully coupled into the at least one waveguide substrate, then totally internally reflected between the major surfaces of said at least one waveguide substrate, until being coupled out of said at least one waveguide substrate via the output region: at this point, monocular alignment between the light engine mounting system and the waveguide combiner is achieved.

In preferred embodiments, the waveguide combiner further comprises rear and front outer covers to at least partially encapsulate the waveguide combiner, wherein the rear outer cover comprises a cavity configured to receive the mount housing, wherein the rear cover outer cavity and the mount housing are shaped such that insertion of mount housing into the rear outer cover cavity aligns the mount housing axis along a predetermined direction.

Thus, the waveguide combiner is at least partially encapsulated by a rear outer cover and a front rear cover. A sealing gasket placed in between the rear and front outer covers may allow for fully encapsulating the waveguide combiner so as to protect it from any ingress that could perturb its operation. The light engine mounting system is placed in a cavity located in the rear outer cover, which aligns the mount housing axis along a predetermined direction to aid with aligning the light engine with the input region of the waveguide combiner.

For instance, the rear outer cover cavity extends through the entire thickness of the rear outer cover along a given direction and the light engine mounting system may be inserted within said cavity such that the mount housing axis aligns along said given direction. The rear outer cover cavity can be oriented in any direction, which offers the possibility to a have a plurality of adjacent light engine mounting systems, each targeting the same input region or different input regions.

Preferably, the augmented reality or virtual reality display comprises:
a second light engine mounting system according to the first aspect of the invention, to provide a second image-bearing light, the second image-bearing light representing a second image, respectively;
a second waveguide combiner being fixed in the frame and comprising at least one waveguide substrate, the at least one waveguide substrate of the second waveguide combiner having a second input region and a second output region to couple the second image-bearing light into and out of the at least one waveguide substrate of the second waveguide combiner, the second input region of the at least one waveguide substrate of the second waveguide combiner having a perimeter; and
   wherein the adjustable mount body of the second light engine mounting system is able to at least partially rotate within its respective mount housing cavity around at least its respective first rotation axis, in order to change where the second image-bearing light falls relative to the perimeter of the second input region of the at least one waveguide substrate of the second waveguide combiner, such that the second image-bearing light may be coupled into the at least one waveguide substrate of the second waveguide combiner, then steered towards the second output region of the at least one waveguide substrate of the second waveguide combiner and coupled out of the at least one waveguide substrate of the second waveguide combiner; wherein preferably the first and second images may be either substantially similar, or have substantially similar portions and substantially different portions.

In this way, by partially rotating the adjustable mount body of each of the first and second light engine mounting systems within their respective mount housing cavity around at least their respective first rotation axis, it is possible to modify the first direction of the light engine of each of the first and second light engine mounting systems such that the first image-bearing light (emitted by the light engine of the first light engine mounting system) fall relative to the perimeter of the input region of the at least one waveguide substrate of the first waveguide combiner and that the second image-bearing light (emitted by the light engine of the second light engine mounting system) fall relative to the perimeter of the input region of the at least one waveguide substrate of the second waveguide combiner.

The first image-bearing light may initially fall outside the perimeter of the input region of the at least one waveguide substrate of the first waveguide combiner. Then, by modifying the first direction of the light engine of the first light engine mounting system, the whole beam of the first image-bearing light may fall first partially within said perimeter. Subsequently, the whole beam may fully fall within said perimeter such that the first image-bearing light is fully coupled into the at least one waveguide substrate of the first waveguide combiner, then totally internally reflected between the major surfaces of said at least one waveguide substrate, until being coupled out of said at least one waveguide substrate via the output region: at this point, monocular alignment between the first light engine mounting system and the first waveguide combiner is achieved.

Similarly, the second image-bearing light may initially fall outside the perimeter of the input region of the at least one waveguide substrate of the second waveguide combiner. Then, by modifying the first direction of the light engine of the first light engine mounting system, the whole beam of the first image-bearing light may fall first partially within said perimeter. Subsequently, the whole beam may fully fall within said perimeter such that the first image-bearing light is fully coupled into the at least one waveguide substrate of the second waveguide combiner, then totally internally reflected between the major surfaces of said at least one waveguide substrate, until being coupled out of said at least one waveguide substrate via the output region: at this point, monocular alignment between the second light engine mounting system and the second waveguide combiner is achieved.

And the first image encoded in the first image-bearing light emitted by the light engine of the first light engine mounting system may be substantially identical to or share some common portions with the second image encoded in the second image-bearing light emitted by the light engine of the second light engine mounting system, which offers the possibility for achieving binocular alignment.

According to a third aspect of the present invention, there is provided a method for adjusting a light engine mounting system relative to a waveguide combiner comprising:
1) providing a first light engine mounting system according to the first aspect of the invention;
2) providing a first waveguide combiner fixed within a frame, and comprising at least one waveguide substrate having a first input region and a first output region;
3) actuating the light engine of the first light engine mounting system to emit a first image-bearing light; and
4) at least partially rotating the adjustable mount body of the first light engine mounting system within the mount housing cavity around at least the first rotation axis to ensure that the first image-bearing light falls within the perimeter of the first input region of the at least one waveguide substrate so as to be coupled into the at least one waveguide substrate, then steered towards the first output region and coupled out of the at least one waveguide substrate.

Consequently, this method for adjusting the light engine mounting system relative to a waveguide combiner allows for achieving monocular alignment between the light engine of the light engine mounting system and the waveguide combiner such that the image-bearing light emitted by the light engine of the light engine mounting system is conveyed through the waveguide combiner without undergoing major alterations.

In preferred embodiments, wherein in step 1) the first light engine mounting system is provided according to the first aspect of the invention such that that the mount body is translatable within the mount housing cavity; in step 3) the first image-bearing light represents a first image and wherein step 4) further comprises translating the adjustable mount body within the mount housing cavity along the direction of the mount housing axis until the first image is in focus at the first input region.

In this way, it is possible to have the distance between the exit point of the first image-bearing light (representing the first image) from the light engine of the first light engine mounting system and the target point located within the first input region coincide with the focal distance of the optical assembly of said light engine such that the first image is in focus at the first input region and the first image output by the first waveguide combiner is well-defined and perceived as such by the entity that is to perceive it. If the first image is not in focus at the first input region, the first image output by the first waveguide combiner will not be well-defined and perceived as such by the entity that is to perceive it, leading to difficulties for understanding the first image by said entity.

According to a fourth aspect of the present invention, there is provided a method for adjusting two light engine mounting systems and two waveguide combiners, comprising:
1) providing first and second light engine mounting systems, each according to the first aspect of the invention;
2) providing a frame;
3) providing first and second waveguide combiners, each being fixed within the frame and each comprising at least one waveguide substrate having input and output regions, the input regions of the at least one waveguide substrate of first and second waveguide combiners having each a perimeter;
3) providing an image-treatment device comprising first and second optical sensors;
4) actuating the light engine of first light engine mounting system to emit a first image-bearing light, the first image-bearing light representing a first image;
5) actuating the light engine of second light engine mounting system to emit a second image-bearing light, the second image-bearing light representing a second image; and
6) at least partially rotating the adjustable mount body of the first light engine mounting system within its respective mount housing cavity around at least its respective first rotation axis to ensure that the first image-bearing light falls within the perimeter of the input region of the at least one waveguide substrate of the first waveguide combiner so as to be coupled into said at least one waveguide substrate, then steered towards the output region of the at least one waveguide substrate of the first waveguide combiner and coupled out of said at least one waveguide substrate towards the first optical sensor; and/or at least partially rotating the adjustable mount body of the second light engine mounting system within its respective mount housing cavity around at least its respective first rotation axis to ensure that the second image-bearing light falls within the perimeter of the input region of the at least one waveguide substrate of the second waveguide combiner so as to be coupled into said at least one waveguide substrate, then steered towards the output region of the at least one waveguide substrate of the second waveguide combiner and coupled out of said at least one waveguide substrate towards the second optical sensor; such that the image-treatment device perceives the first and second images as positioned relative to one another on a same plane.

In this way, at least partially rotating the adjustable mount body of one or each of the first and second light engine mounting systems within its or their respective mount housing cavity around at least its or their respective first rotation axis allows for positioning the first and second images (each image output by a given waveguide combiner, being captured by a given camera or other optical sensor and transmitted to the image-treatment device) perceived by the image-treatment device on a same plane relative to one another. The optical sensors and image treatment device can optionally be used to check the relative alignment of the first and second images before and/or during the adjustment of the or each adjustable mount body. The adjustment process may be iterative. The judgement as to whether the relative alignment of the first and second images is as desired may be performed by appropriately programmed software or by an operator viewing the detected images as perceived by the image-treatment device, e.g. as shown on a monitor or other output device.

When the desired alignment is achieved, adhesive can be added to permanently fix the adjustable mount body of each light engine mounting system within its respective mount housing cavity.

Preferably, in step 6) the at least partially rotating achieves at least partial, preferably full binocular alignment, such that the image-treatment device perceives the first and second images as at least partially, preferably fully, overlapping one another.

Therefore, at least partially rotating the adjustable mount body of one or each of the first and second light engine mounting systems within its or their respective mount housing cavity around at least its or their respective first rotation axis allows for controlling the extent of overlap between the first and second images perceived by the image-treatment device and thus dictating the desired degree of binocular alignment i.e. partial or full binocular alignment. A benefit of adjusting two light engine mounting systems to achieve (only) partial binocular alignment is to allow for enlarging the virtual graphic information-related field of view of a user horizontally and/or vertically during later use of the device, when said user wears the augmented reality display made of two light engine mounting systems and two waveguide combiners fixed in a frame. The user's virtual graphic information-related field of view obtained via partial binocular alignment is greater than the one obtained via full binocular achievement. This may be desirable in some applications. In other cases, it may be preferably to provide full binocular alignment. This maximises the area across which a user will be able to perceive stereographic three-dimensional images when using the display, which in turn has the potential to make augmented reality more immersive. This can be achieved by arranging for the overlapped portions of said images to display related virtual graphic information exhibiting the same content from different viewing points, in use.

In particularly preferred embodiments, at least a first part of the first image and at least a first part of a second image each comprise the same common virtual graphic information, and in step 6), the at least partially rotating is such that the image-treatment device perceives the first and second images to be positioned such that the first part of the first image and the first part of the second image overlap and are aligned with one another.

Hence, the overlap between the first and second images perceived by the image treatment device involves parts (of said image) that are substantially identical to one another. The first part may be less than the whole of the respective image (partial binocular alignment) or could correspond to the whole respective image (full binocular alignment). Having the first and second images displaying common virtual graphic information (i.e. information which is substantially identical in both images) in at least a first part of each image allows for implementing partial or full binocular alignment by having identical parts of said images (perceived by the image-treatment device) coincide with one another, via the at least partial rotation of the adjustable mount body of one or each of the first and second light engine mounting systems within its or their respective mount housing cavity around at least its or their respective first rotation axis. Advantageously, the common graphical information is selected such that any misalignment between the overlapped parts of the first and second images will be readily apparent. For example, the common graphical information could comprise an image of a crosshair or other detailed pattern or graphic which will reveal any misalignment between the first and second images.

In the case of partial binocular alignment, the image-treatment device typically perceives a two-dimensional image made of a central portion occupied by the overlap between the first and second images and two peripheral portions accommodating the non-overlapping parts of either the first image or the second image.

In the case of full binocular alignment, the image-treatment device typically perceives a two-dimensional image corresponding to the full overlap between the first and second images obtained by at least partially rotating the adjustable mount body of one or each of the first and second light engine mounting systems within its or their respective mount housing cavity around at least its or their respective first rotation axis.

Preferably, at least a second part of the first image and at least a second part of the second image each comprise virtual graphic information which is different from the common virtual graphic information and preferably different from one another, and in step 6), the at least partially rotating is such that the image-treatment device perceives the first and second images to be positioned such that the second part of the first image does not overlap the second part of the second image.

In this way, the images used for the adjustment process clearly delineate between the first and second parts of each image so that it can be accurately judged when the desired partial overlap has been achieved by the adjustment. The virtual graphic information in the second part of each image can be of any sort and may be different between the first and second images.

When considering partial binocular alignment, the image-treatment device perceives a two-dimensional image made of a central portion occupied by the overlap between the first and second images and two peripheral portions accommodating the non-overlapping parts of either the first image or the second image.

This method for adjusting two light engine mounting systems and two waveguide combiners allows the manufacture to achieve partial or full binocular alignment in an easy, fast, cost-effective and reversible way (up to the addition of adhesive to permanently fix the adjustable mount body of each of the first and second light engine mounting systems within their respective mount housing cavity) which avoids potential damage to the product and possible wastage.

Preferably, step 6) comprises further translating the adjustable mount body of each of the first and second light engine mounting systems within its respective mount housing cavity such that the first and second images are in focus at the input region of the at least one waveguide substrate of the first and second waveguide combiners, respectively.

In this way, it is possible to have the distance between the exit point of the first image-bearing light (representing the first image) from the light engine of the first light engine mounting system and the target point located within the input region of the at least one waveguide substrate of the first waveguide combiner coincide with the focal distance of the optical assembly of said light engine such that the first image is in focus at said input region and the first image output by the first waveguide combiner towards the first optical sensor will be well-defined and perceived as such by the image-treatment device.

Similarly, it is possible to have the distance between the exit point of the second image-bearing light (representing the second image) from the light engine of the second light engine mounting system and the target point located within the input region of the at least one waveguide substrate of the second waveguide combiner coincide with the focal distance of the optical assembly of said light engine such that the second image is in focus at said input region and the second image output by the second waveguide combiner towards the second optical sensor will be well-defined and perceived as such by the image-treatment device.

Having the first and second images well-defined facilitates the partial or full overlap of the first and second images, and thus the partial or full binocular alignment between two light engine mounting system/waveguide combiner combinations.

In preferred embodiments, the or each light engine mounting system is provided according to the first aspect of the invention with second holes for injecting adhesive into the mount housing cavity, and further comprising, after at least partially rotating the adjustable mount body of the or each light engine mounting system, injecting an adhesive through the or each second hole in order to permanently fix the adjustable mount body in place in the cavity of the or each light engine mounting system.

Thus, when the desired degree of binocular alignment between two light engine mounting system/waveguide combiner combinations is achieved, each adjustable mount body is then permanently fixed in a given position within its respective mount housing cavity by injecting some adhesive via the or each second hole: the resulting binocular display is then ready to be worn by a user.

According to a fifth aspect of the present invention, there is provided a method of displaying images, comprising:
1) providing a first light engine mounting system and a second light engine mounting system, each according to a first aspect of the invention;
2) providing a frame;
3) providing first and second waveguide combiners, each being fixed in the frame and each having at least one waveguide substrate having input and output regions, the input regions of the first and second waveguide combiners having each a perimeter;
4) actuating the light engine of the first light engine mounting system to emit a first image-bearing light representing a first image, such that the first image-bearing light is coupled into and out from the at least one waveguide substrate of the first waveguide combiner via the input and output regions of the at least one waveguide substrate of the first waveguide combiner, respectively towards a user; and
5) actuating the light engine of the second light engine mounting system to emit a second image-bearing light representing a second image, such that the second image-bearing light is coupled into and out from the at least one waveguide substrate of the second waveguide combiner via the input and output regions of the at least one waveguide substrate of the second waveguide combiner, respectively towards a user;
   wherein the adjustable mount body of each of the first and second light engine mounting systems is oriented within its respective mount housing cavity such that the first image-bearing light falls within the perimeter of the input region of the at least one waveguide substrate of the first waveguide combiner, the second image-bearing light falls within the perimeter of the input region of the at least one waveguide substrate of the second waveguide combiner and the user perceives the first and second images as positioned relative to one another on a same plane as at least partially, preferably fully, overlapping one another, whereby at least partial, preferably full, binocular alignment is achieved, respectively.

In this way, prior adjustments of the adjustable mount body of each of the first and second light engine mounting systems within its respective mount housing cavity allows a user to perceive the first and second images on a same plane at least partially, preferably fully overlapping, whereby at least partial, preferably full, binocular alignment is achieved, respectively.

Preferentially, at least a first part of the first image and at least a first part of the second image each comprise the same common virtual graphic information, and the adjustable mount body of each of the first and second light engine mounting systems is oriented within its respective mount housing cavity, such that the user perceives the first and second images to be positioned such that the first part of the first image and the first part of the second image overlap and are aligned with one another.

Hence, the overlap between the first and second images perceived by the user involves parts (of said images) that are substantially identical to one another. The part may be less than the whole of the respective image (partial binocular alignment) or could correspond to the whole respective image (full binocular alignment). In the case of partial binocular alignment obtained by the prior adjustments of the adjustable mount body of one or each of the first and second light engine mounting systems within its or their respective mount housing cavity, if common virtual graphic information is provided in the overlapping parts of the two images, the user perceives a two-dimensional image made of a central portion occupied by the overlap between the first and second images and two peripheral portions accommodating non-overlapping parts of either first image or second image.

Accordingly, partial binocular alignment obtained via prior adjustments of the adjustable mount body of one or each of the first and second light engine mounting systems within its or their respective mount housing cavity, allows for enlarging the virtual graphic information-related field of view of a user horizontally and/or vertically. The user's virtual graphic information-related field of view obtained via partial binocular alignment is greater than the one obtained via full binocular alignment (assuming the size of each image is constant).

In the case of full binocular alignment, if common virtual graphic information is provided in the overlapping parts of the two images, the user perceives a two-dimensional image corresponding to the overlap between the first and second images obtained by prior adjustments of the adjustable mount body of one or both light engine mounting systems.

In particularly preferred embodiments, at least a first part of the first image and at least a first part of the second image each comprise related virtual graphic information exhibiting the same content from different viewing points, and the adjustable mount body of each of the first and second light engine mounting systems is oriented within its respective mount housing cavity, such that the user perceives the first and second images to be positioned such that the first part of the first image and the first part of the second image overlap and are aligned with one another, and appear as a stereographic three-dimensional image.

In this way, the overlap between the first and second images result in the formation of a stereographic three-dimensional image, means to make augmented reality more immersive.

Furthermore, in the case of the partial binocular alignment obtained via prior adjustments of the adjustable rotatable mount of one or each of the first and second light engine mounting systems within its or their respective mount housing cavity, the user perceives an image made of a stereographic three-dimensional central portion occupied by the overlap between the first and second images, and two dimensional peripheral portions accommodating non-overlapping parts of either first image or second image. Accordingly, partial binocular alignment obtained via prior adjustments of the adjustable mount body of one or each of the first and second light engine mounting systems within its or their respective mount housing cavity allow for enlarging the virtual graphic information-related field of view of a user horizontally and/or vertically. The user's virtual graphic information-related field of view obtained via partial binocular alignment is greater than the one obtained via full binocular achievement (assuming the size of each image is constant).

In the case of full binocular alignment obtained via prior adjustments of the adjustable mount body of one or each of the first and second light engine mounting systems within its or their respective mount housing cavity, if the whole of the first and second images each contain related virtual graphic information exhibiting the same content from different viewing points, the user perceives a fully stereographic three-dimensional image corresponding to substantially the whole field of view.

Preferably, at least a second part of the first image and at least a second part of the second image each comprise virtual graphic information which is different from that in the respective first parts and preferably from one another, and the adjustable mount body of each of the first and second light engine mounting systems is oriented within its respective mount housing cavity such that the user perceives the first and second images to be positioned such that the second part of the first image does not overlap the second part of the second image.

In this way, the non-overlapping parts of the field of view may be readily distinguished from the overlapping portion and may be used to display different forms of information from that in the overlapping portion. For example, the non-overlapping parts of each image could be used to display text, number or other data while the overlapping parts could be arranged to display a stereographic image of a person, object or other scene.

The methods of displaying images allow the user to “imprint” either stereographic three-dimensional images or two-dimensional images, or a mixture thereof on their surroundings with the possibility to tune the extent and shape of the user's virtual graphic information-related field of view.

In preferred embodiments, the adjustable mount body of each of the first and second light engine mounting systems is placed within its respective mount housing cavity such that the first and second images are in focus at the input region of the at least one waveguide substrate of the first and second waveguide combiners, respectively.

In this way, the distance between the exit point of the first image-bearing light (representing the first image) from the light engine of the first light engine mounting system and the target point located within the input region of the at least one waveguide substrate of the first waveguide combiner coincide with the focal distance of the optical assembly of said light engine such that the first image is in focus at said input region and the first image output by the first waveguide combiner towards one eye of the user is well-defined and perceived as such by the user.

Similarly, the distance between the exit point of the second image-bearing light (representing by the second image) from the light engine of the second light engine mounting system and the target point located within the input region of the at least one waveguide substrate of the second waveguide combiner coincide with the focal distance of the optical assembly of said light engine such that the second image is in focus at said input region and the second image output by the second waveguide combiner towards the other eye of the user is well-defined and perceived as such by the user.

Having the first and second images well-defined allows the user to experience the intended degree of overlap of the first and second images, and thus the intended degree of binocular alignment (that was selected during the adjustment of the adjustable mount body of each of the first and second light engine mounting systems within their respective mount housing cavity).

### BRIEF DESCRIPTION OF THE DRAWINGS

Examples of light engine mounting systems in accordance with embodiments of the invention will now be described with reference to accompanying drawings, in which:

FIGS. 1, 2 and 3 represent each a given schematic view of a light engine mounting system according to a first embodiment of the present invention:

FIG. 1 shows a side view of the cross-sectioned light-engine mounting system according to the first embodiment of the present invention;

FIG. 2 depicts a top view of the cross-sectioned light-engine mounting system according to the first embodiment of the present invention;

FIG. 3 represents a front view of the cross-sectioned light-engine mounting system according to the first embodiment of the present invention.

FIGS. 4, 5 and 6 illustrate each a given schematic view of a light engine mounting system according to a second embodiment of the present invention:

FIG. 4 shows a side view of the cross-sectioned light-engine mounting system according to the second embodiment of the present invention;

FIG. 5 depicts a top view of the cross-sectioned light-engine mounting system according to the second embodiment of the present invention;

FIG. 6 represents a front view of the crossed-sectioned light-engine mounting system according to the second embodiment of the present invention.

FIGS. 7 and 8 depict each a schematic view of an Augmented Reality (AR) or Virtual Reality (VR) display comprising a single light-engine mounting system and a single waveguide combiner, according to another embodiment of the present invention:

FIG. 7 depicts the case where the adjustable mount body does not need to be used to achieve monocular alignment between the light-engine mounting system and the waveguide combiner;

FIG. 8 represents the case where the adjustable mount body is operated to achieve monocular alignment between the light-engine mounting system and the waveguide combiner.

FIGS. 9 and 10 represent each a schematic view of an AR or VR display comprising an immobilised waveguide combiner at least partially encapsulated between a front outer cover and a rear outer cover and a light-engine mounting system integrated within a rear outer cover cavity, in accordance with another embodiment of the present invention:

FIG. 9 shows the case where the cavity is neither horizontally-oriented nor vertically oriented but tilted;

FIG. 10 depicts the case where the cavity is horizontally-oriented.

FIGS. 11 to 14 show a schematic view of an AR or VR display comprising two light-engine mounting system/waveguide combiner combinations, according to another embodiment of the present invention:

FIG. 11 depicts the case where there is no binocular alignment between those two combinations;

FIGS. 12 and 13 represent the case where there is partial binocular alignment along two directions or one direction, respectively;

FIG. 14 illustrates the case where there is full binocular alignment.

### DETAILED DESCRIPTION

The present invention can operate with any kind of projectors including projectors based on self-emissive display panels e.g. microLED (Light Emitting Diode) panel displays, or reflective display panels e.g. Liquid Crystal on Silicon (LCoS) or Digital Mirror Device (DMD).

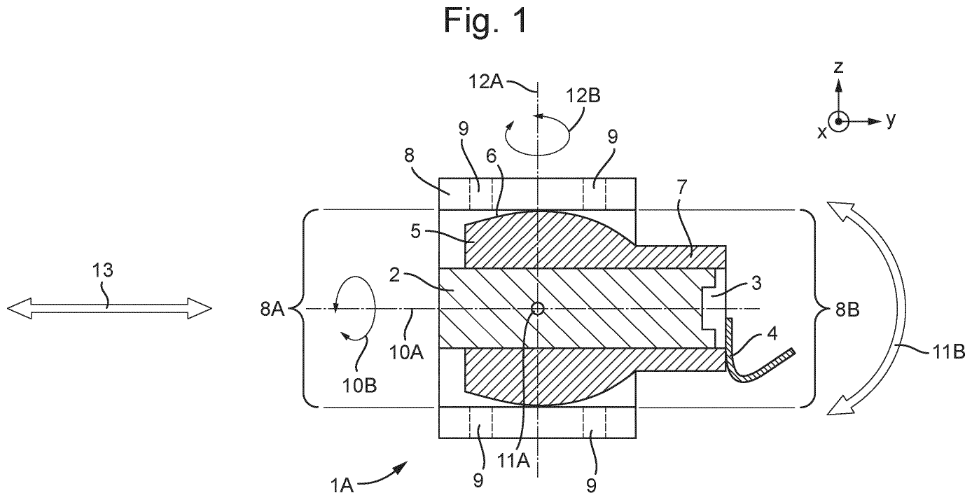

FIGS. 1 to 3 show a light-engine mounting system according to a first embodiment of the present invention, which enables the three-dimensional adjustment of a projector by at least partially rotating an adjustable mount body (accommodating said projector) within a mount housing cavity around a first rotation axis and/or a second rotation axis and by reversibly locking it into a given position in order to select the propagation direction of the image-bearing light the projector emits and thus its potential target (which could be a specific location on an input region of a waveguide substrate of a waveguide combiner such as a centre point of the input region). The three-dimensional adjustment of the projector also encompasses the possibility to translate the adjustable mount body to some extent within the mount housing cavity to have the image output by the projector in focus at the target point that may be for instance the input region of the waveguide substrate.

FIG. 1 depicts a side view 1A of a cross-sectioned light-engine mounting system according to the first embodiment of the present invention: the z-y plane cross-sections the light-engine mounting system in two equal pieces and the piece depicted in FIG. 1 is its left-hand half. The light-engine mounting system comprises a projector 2, an adjustable mount body 5 and a mount housing 8.

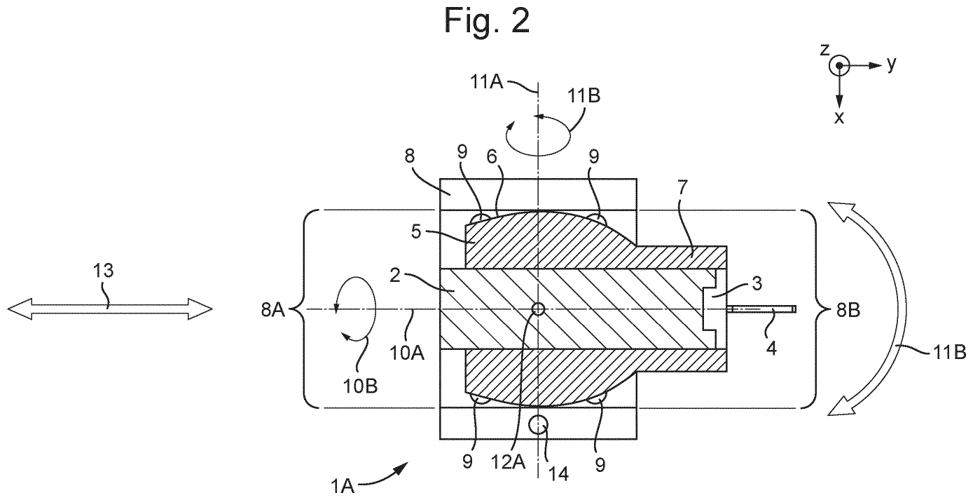

Projector 2 comprises a microLED display panel 3 (as image source) coupled to an electrical connector 4, and an internal optical assembly through which the image-bearing light is directed from microLED display panel 3 to the exit aperture of the projector. Adjustable mount body 5 comprises a cavity (which is partially shown in FIGS. 1 to 3 but not labelled for the sake of clarity) to receive projector 2, a curved portion 6 to facilitate its at least partial rotation within a mount housing 8 cavity (which is partially shown in FIGS. 1 to 3 but not labelled for the sake of clarity), a handle 7 to enable its at least partial multi-axis rotation (that could be clockwise or anticlockwise irrespective of the considered rotation axis) within the mount housing cavity around a first rotation axis 11A (shown as a double arrow 11B) and/or a second rotation axis 12A (shown as a double arrow 12B). Mount housing 8 may be fixed. The mount housing 8 cavity is substantially cylindrical and extends from a front aperture 8A to a rear aperture 8B along the direction of a mount housing axis 10A which is perpendicular to both front and rear apertures 8A, 8B. Front and rear apertures 8A, 8B are located in front and rear faces, respectively. (The front and rear faces are partially shown in FIGS. 1 to 2 but not labelled for the sake of clarity.) The image-bearing light emitted by microLED display panel 3 first exits projector 2 via the exit aperture of projector 2, then leaves mount housing 8 cavity via front aperture 8A to finally reach its target point located outside of the light engine mounting system. Handle 7 protrudes from rear aperture 8B. Up to eight orifices 9 that extend through the mount housing 8 thickness to reach the mount housing 8 cavity are provided for the ingress of a locking fluid, such as an adhesive, which may be used to permanently fix adjustable mount body 5. The adhesive may also prevent ingress of debris or moisture, which are potentially detrimental to the operation of the light-engine mounting system. The external walls of the curved portion 6 of adjustable mount body 5 fit into the internal walls of the mount housing 8 cavity and facilitates the at least partial rotation of adjustable mount body 5 within mount housing 8 cavity around first rotation axis 11A and/or second rotation axis 12A and/or mounting housing axis 10A. Additionally, it facilitates a limited translation of adjustable mount body 5 within the mount housing 8 cavity along the direction of mount housing axis 10A.

Mount housing axis 10A, first rotation axis 11A and second rotation axis 12A all intersect at a single point which is the centre of curved portion 6 of adjustable mount body 5. First rotation axis 11A relates to the pitch adjustment of the light engine mounting system while second rotation axis 12A to its yaw adjustment. Here, projector 2 is positioned relative to mount housing 8 such that mount housing axis 10A and the propagation direction of the image-bearing light are superimposed on each other: mount housing axis 10A acts as if it were a symmetry axis for projector 2. In other words, the image-bearing light emitted by projector 2 follows the direction of mount housing axis 10A. For the sake of clarity, the propagation direction of the image-bearing light is neither indicated nor labelled in FIG. 1. At least partially rotating adjustable mount body 5 within mount housing 8 cavity around first rotation axis 11A and/or second rotation axis 12A allows for setting a propagation direction of the image-bearing light emitted by projector 2 (and thus the propagation direction of the image of the image-bearing light) that could be different to the direction of mount housing axis 10A, which offers some leeway to correct (to some extent) any optical misalignment between the projector and a target positioned at given location.

Additionally, adjustable mount body 5 can be translated to some extent within the cylindrical cavity of mount housing 8 along the direction of the mount housing axis 10A: a double arrow 13 expresses the possibility for adjustable mount body 5 to move along the direction of mount housing axis 10A in both opposite ways, to have the image I output by projector 2 in focus at the target point which may be the input region of a waveguide substrate. Handle 7 can also be used to perform the limited translation of adjustable mount body 5 within the mount housing 8 cavity along the direction of mount housing axis 10A.

Furthermore, adjustable mount body 5 can at least partially rotate around mount housing axis 10A clockwise or anticlockwise as shown by a double arrow 10B to adjust the roll of the image. This at least partial rotation around mount housing axis 10A is implemented via handle 7.

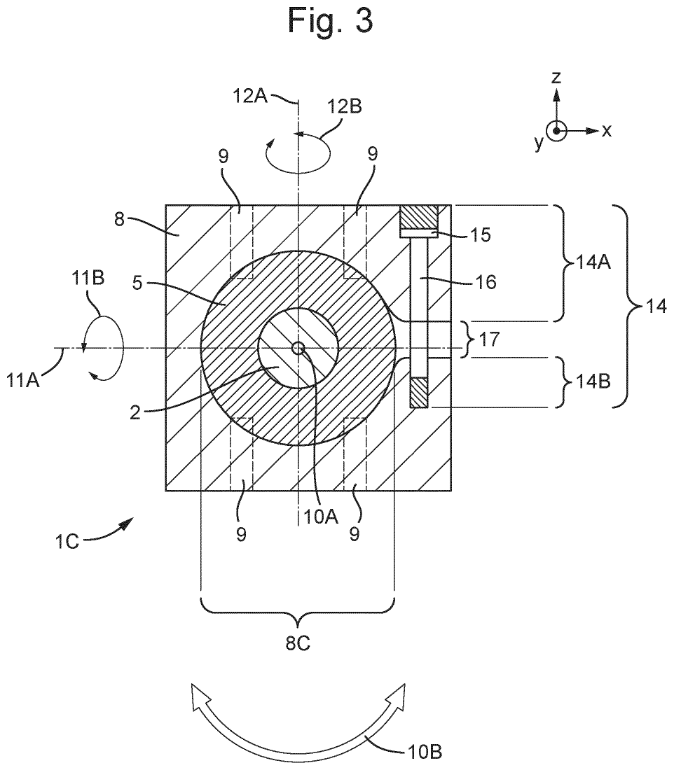

FIG. 2 represents a top view 1B of the cross-sectioned light-engine mounting according to the first embodiment of the present invention: the x-y plane cross-sections the light-engine mounting system in two equal pieces and the piece depicted in FIG. 2 is its bottom half. FIG. 2 displays the same elements as FIG. 1 with the addition of a hole 14 (which extends into the mount housing 8 thickness while avoiding the mount housing 8 cavity) to accommodate a partially-threaded screw 16 (shown in FIG. 3), both being part of the clamping mechanism to reversibly lock adjustable mount body 5 within mount housing 8 cavity into a given position. Hole 14 comprises a non-threaded portion and a threaded portion and the partially-threaded screw 16 is provided with a non-threaded portion and a threaded portion, as it will be described with reference to FIG. 3.

FIG. 3 depicts a front view 1C of the cross-sectioned light-engine mounting system according to the first embodiment of the present invention: the z-x plane cross-sections the light-engine mounting system in two equal pieces and the piece depicted in FIG. 3 is its rear half. FIG. 3 focuses on the clamping mechanism which is used to reversibly lock adjustable mount body 5 within mount housing 8 into a given position, prior to permanent fixture using adhesive as described with reference to FIG. 1. Mount housing cavity is substantially cylindrical: front aperture 8A, rear aperture 8B and cross-section related aperture 8C have all the same size. The exit point of the image from projector 2 is located within front aperture 8A of the mount housing 8 cavity. Mount housing 8 has a slot formed through its thickness oriented along the direction of mount housing axis 10A and extending from front aperture 8A to rear aperture 8B. The extent of the slot through the light-engine mounting system is depicted by a gap 17.

Hole 14 is provided through the thickness of mount housing 8 in a direction perpendicular to gap 17. Hole 14 comprises a non-threaded portion 14A and a threaded portion 14B aligned with each other and separated by gap 17. Threaded portion 14A extends through the thickness of mount housing 8 between an external surface of mount housing 8 and an inner surface of mount housing 8 revealed by gap 17. Non-threaded portion 14B extends through the thickness of mount housing 8 between another external surface of mount housing 8 and another inner surface revealed by gap 17. The partially-threaded screw 16 has two ends: one end, its head, is exposed, has an interface to enable its rotation and engages a rebate 15, which blocks penetration of the head further into non-threaded portion 14A but permits the rotation of partially-threaded screw 16 (which may be clockwise or anticlockwise); while the other end, its tip, is located in threaded portion 14B of hole 14. Threaded portion of partially-threaded screw 16 is located at least in threaded portion 14B of hole 14 and may be present in gap 17 at most. Non-threaded portion of partially-threaded screw 16 is located in non-threaded portion 14A of hole 14.

As partially-threaded screw 16 is rotated clockwise within threaded portion 14B of hole 14, the head of partially-threaded screw 16 pulls and reduces gap 17, compressing mount housing 8 against adjustable mount body 5, until temporarily locking adjustable mount body 5 within mount housing 8 cavity, which renders at least partial rotation of adjustable mount body 5 within the mount housing 8 cavity and/or limited translation of adjustable mount body 5 within the mount housing 8 cavity along the direction of mount housing axis 10A impossible.

Turning partially-threaded screw 16 anticlockwise results in an increase of gap 17, which at a given point will permit at least partial rotation of adjustable mount body 5 within mount housing 8 cavity and/or its limited translation within the mount housing 8 cavity along the direction of mount housing axis 10A. Controlling mount housing 8 cavity size determines whether adjustable mount body 5 can at least partially rotate within mount housing 8 cavity and/or translate within mount housing 8 cavity. However, once adhesive has been applied via orifices 9, adjustable mount body 5 is permanently fixed within mount housing 8 cavity, and thereafter manipulation of partially-threaded screw 16 has no further impact.

Rebate 15 allows for maintaining the head of partially-threaded screw 16 below the level of the external surface of mount housing 8 in contact with the non-threaded portion 14A of hole 14, which may useful when a whole light engine mounting system is to be inserted into a cavity.

If the tip of partially-threaded screw 16 were to protrude from the external surface of mount housing 8 in contact with the threaded portion 14B of hole 14 (in other words, threaded portion 14B of hole 14 would extend from one inner surface of mount housing 8 revealed by gap 17 to said external surface), the clamping mechanism would still work.

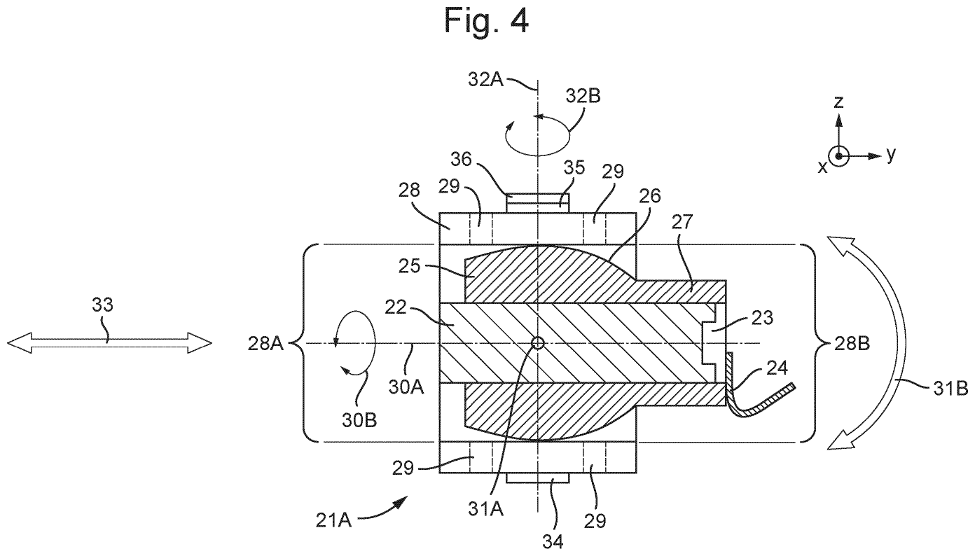

FIGS. 4 to 6 show a light-engine mounting system according to a second embodiment of the present invention, which enables the three-dimensional adjustment of a projector by at least partially rotating an adjustable mount body (accommodating said projector) within a mount housing cavity around a first rotation axis and/or a second rotation axis and by reversibly locking it into a given position in order to select the propagation direction of the image-bearing light the projector emits and thus its potential target (which could be a specific location on an input region of a waveguide substrate of a waveguide combiner such as a centre point of the input region). The three-dimensional adjustment of the projector also encompasses the possibility to translate the adjustable mount body to some extent within the mount housing cavity to have the image of the image-bearing light output by the projector in focus at the target point that may be for instance the input region of the waveguide substrate.

FIG. 4 depicts a side view 21A of the cross-sectioned light-engine mounting system according to a second embodiment of the present invention: the z-y plane cross-sections the light-engine mounting system in two equal pieces and the piece depicted in FIG. 4 is its left-hand half. The light-engine mounting system comprises a projector 22, an adjustable mount body 25, a mount housing 28, a band 34 girding mount housing 28 (without occluding both front and rear apertures 28A, 28B of mount housing 28 cavity) and mechanically coupled to a screw 36, as well as a slit 35 through which a portion of the band passes.

Projector 22 comprises a microLED display panel 23 (as image source) coupled to an electrical connector 24, and an internal optical assembly through which the image-bearing light is directed from microLED display panel 23 to the exit aperture of the projector. Adjustable mount body 25 comprises a cavity (which is partially shown in FIGS. 4 to 6 but not labelled for the sake of clarity) to receive projector 22, a curved portion 26 to facilitate its at least partial rotation within a mount housing 28 cavity (which is partially shown in FIGS. 4 to 6 but not labelled for the sake of clarity), a handle 27 to enable its at least partial rotation (that could be clockwise or anticlockwise irrespective of the considered rotation axis) within the mount housing cavity around a first rotation axis 31A (shown as a double arrow 31B) and/or a second rotation axis 32A (shown as a double arrow 32B). Mount housing 28 may be fixed. The mount housing 28 cavity is substantially cylindrical and extends from a front aperture 28A to a rear aperture 28B along the direction of a mount housing axis 30A, which is perpendicular to both front and rear apertures 28A, 28B. Front and rear apertures 28A, 28B are located in front and rear faces, respectively. (The front and rear faces are partially shown in FIGS. 1 to 2 but not labelled for the sake of clarity.) The image-bearing light emitted by microLED display panel 23 first exits projector 22 via the exit aperture of projector 22, then leaves mount housing 28 cavity via front aperture 28A to finally reach its target point located outside of the light engine mounting system. Handle 27 protrudes from rear aperture 28B. The external corners of mount housing 28 may be rounded off (over a narrow distance) to aid the movement of band 34 as it is tightened or loosened around mount housing 28. The provision of rounded external corners over a narrow distance a little wider than band 34 can prevent lateral movement of band 34 along the length of mount housing 28. Up to eight orifices 29 that extend through the mount housing 28 thickness to reach the mount housing 28 cavity are provided for the ingress of a locking fluid, such as an adhesive, which may be used to permanently fix adjustable mount body 25. The adhesive may also prevent ingress of debris or moisture, which are potentially detrimental to the operation of the light-engine mounting system. The external walls of the curved portion 26 of adjustable mount body 25 fit into the internal walls of the mount housing 28 cavity so as to facilitate the at least partial rotation of adjustable mount body 25 within mount housing 28 cavity around first rotation axis 31A and/or second rotation axis 32A and/or mounting housing axis 30A. Additionally, it facilitates a limited translation of adjustable mount body 25 within the mount housing 28 cavity along the direction of mount housing axis 30A.

The band 34 comprises a plurality of periodically-spaced grooves (not shown here) with some of which the thread of screw 36 is mechanically engaged. An exemplary band would be a Jubilee® clip produced by L Robinson & Co (Gillingham) Limited, UK.

Mount housing axis 30A, first rotation axis 31A and second rotation axis 32A all intersect at a single point which is the centre of curved portion 26 of adjustable mount body 25. First rotation axis 31A relates to the pitch adjustment of the light engine mounting system while second rotation axis 32A to its yaw adjustment. Here, projector 22 is positioned relative to mount housing 28 such that mount housing axis 30A and the propagation direction of the image-bearing light are superimposed on each other: mount housing axis 30A acts as if it were a symmetry axis for projector 22. In other words, the image-bearing light emitted by projector 22 follows the direction of mount housing axis 30A. For the sake of clarity, the propagation direction of the image-bearing light is neither indicated nor labelled in FIG. 3. At least partially rotating adjustable mount body 25 within mount housing 28 cavity around first rotation axis 31A and/or second rotation axis 32A allows for setting a propagation direction of the image-bearing light emitted by projector 22 (and thus the propagation direction of the image of the image-bearing light) that could be different to the direction of mount housing axis 30A, which offers some leeway to correct (to some extent) any optical misalignment between the projector and a target positioned at given location.

Additionally, adjustable mount body 25 can be translated to some extent within the cylindrical cavity of mount housing 28 along the direction of mount housing axis 30A: a double arrow 33 expresses the possibility for adjustable mount body 25 to move along the direction of mount housing axis 30A in both opposite ways, to have the image output by projector 22 in focus at the target point which may be the input region of the waveguide substrate. Handle 27 can also be used to perform the limited translation of adjustable mount 25 within the mount housing 28 cavity along the direction of the mount housing axis 30A.

Furthermore, adjustable mount body 25 can at least partially rotate around mount housing axis 30A clockwise or anticlockwise as shown by a double arrow 30B to adjust the roll of the image. This at least partial rotation around mount housing axis 30A is implemented via handle 27.

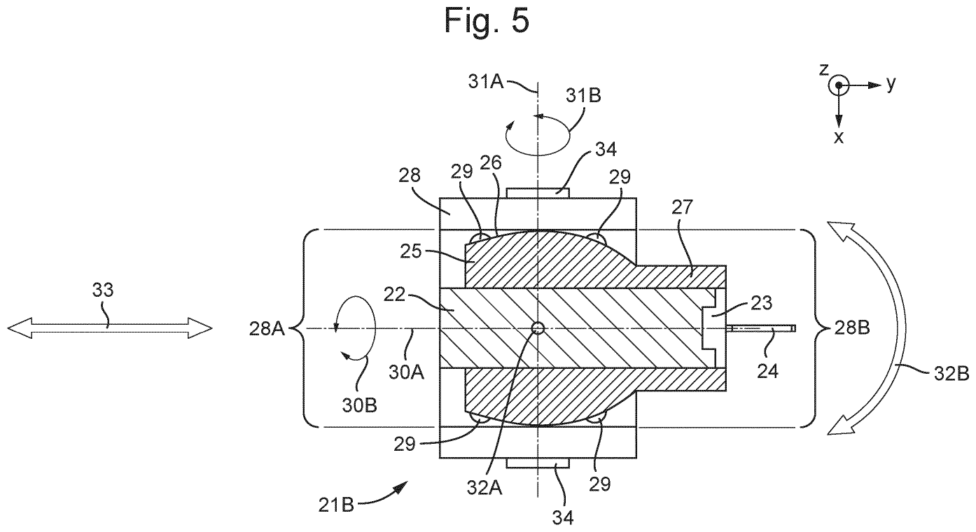

FIG. 5 represents a top view 21B of the cross-sectioned light-engine mounting according to the second embodiment of the present invention: the x-y plane cross-sections the light-engine mounting system in two equal pieces and the piece depicted in FIG. 5 is its bottom half. FIG. 5 displays the same elements as FIG. 4 but misses screw 36 and slit 35 through which a portion of band 34 passes as only the bottom part of the cross-sectioned light-engine mounting system is represented.

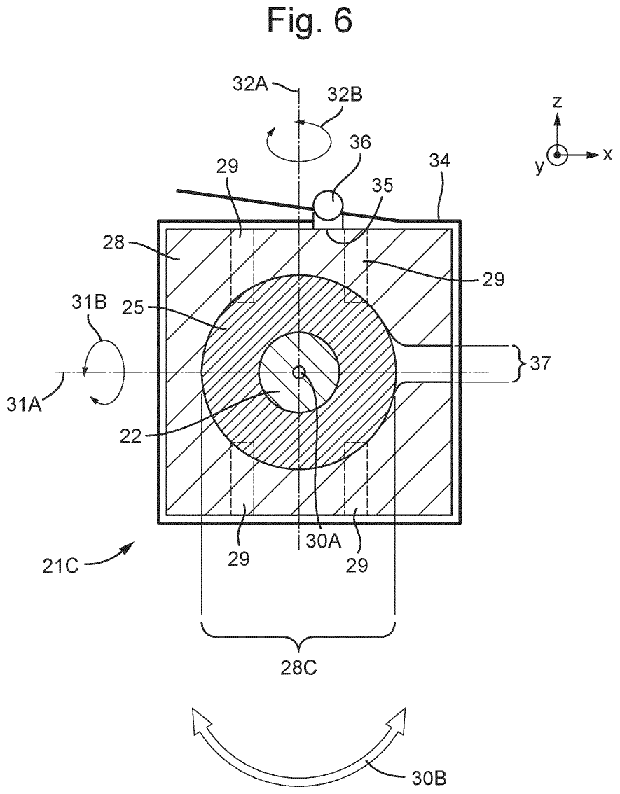

FIG. 6 depicts a front view 21C of the cross-sectioned light-engine mounting system according to the second embodiment of the present invention: the z-x plane cross-sections the light-engine mounting system in two equal pieces and the piece depicted in FIG. 6 is its rear half. FIG. 6 focuses on the clamping mechanism which is used to reversibly lock adjustable mount body 25 within mount housing 28 cavity into a given position, prior to permanent fixture using adhesive as described with reference to FIG. 4. Mount housing 28 cavity is substantially cylindrical: front aperture 28A, rear aperture 28B and cross-section related aperture 28C have all the same size. The exit point of the image from projector 22 is located within front aperture 28A of the mount housing 28 cavity. Mount housing 28 has a slot formed through its thickness oriented along the direction of mount housing axis 30A and extending from front aperture 28A to rear aperture 28B. The extent of the slot through the light-engine mounting system is depicted by a gap 37.

The head of screw 36 is exposed and has an interface to enable its rotation. The band 34 comprises a plurality of periodically-spaced grooves (not shown here), some of which engage the thread of screw 36. The rotation of screw 36 reversibly increases or decreases the extent of the band 34 girding mount housing 28 depending upon the rotation direction and thus reversibly controls the height of gap 37 and the mount housing 28 cavity size. When the mount housing 28 cavity size is marginally greater than the size of curved portion 26 of adjustable mount body 25, adjustable mount body 25 is locked into a given position. When the mount housing 28 cavity size is sufficiently greater than the size of curved portion 26 of adjustable mount body 25, adjustable mount body 25 is able to at least partially rotate within mount housing 28 cavity around first rotation axis 31A and/or the second rotation axis 32A.

Additionally, the slot formed through the thickness of mount housing 28 can adopt any direction between the front and rear apertures 28A, 28B of the mount housing 28 cavity as long as it is positioned outside the mount housing 28 cavity, but extends from an external surface of mount housing 28 to the mount housing 28 cavity.

Furthermore, the clamping mechanism of the second embodiment of the present invention could rely on devices similar to Jubilee® clips such as a reversible cable tie or may be different to Jubilee® clip such as a bulldog clip or similarly resiliently biased clamping spring that can be applied to close gap 37.

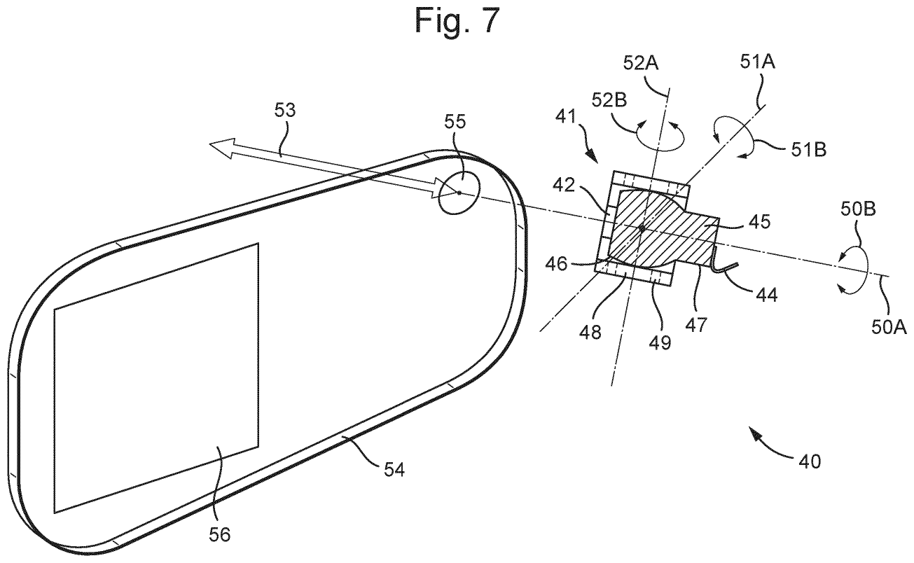

FIG. 7 shows an embodiment of an Augmented Reality (AR) or Virtual Reality (VR) display 40, more specifically a cross-sectional view of a light-engine mounting system 41 in accordance with the first or second embodiment of the present invention, monocularly aligned with a fixed waveguide combiner to form an augmented reality display 40. (In FIG. 7, light-engine mounting system 41 is partially cross-sectioned so as to make the position of its adjustable mount body within its mount housing cavity clearly visible.)

The waveguide combiner comprises a single waveguide substrate 54 having an input region 55 and an output region 56. The waveguide combiner may comprise a plurality of waveguide substrates stacked together, each having an input region and an output region.

The image-bearing light emitted by the projector held within the adjustable mount body is steered towards the centre of the input region of the waveguide substrate so as to be coupled into the waveguide substrate. The image-bearing light then travels by total internal reflection within the waveguide substrate towards the output region, from where it is coupled out of the waveguide substrate via the output region towards an optical sensor (not shown here) that may be a camera or an eye of a viewer.

Light-engine mounting system 41 comprises a projector 42, an adjustable mount body 45 and a mount housing 48. Projector 42 comprises a microLED display panel—not shown here-(as image source) coupled to an electrical connector 44, and an internal optical assembly through which the image-bearing light is directed from the microLED display panel to the exit aperture of the projector. Adjustable mount body 45 comprises a cavity to receive projector 42, a curved portion 46 to facilitate its at least partial rotation within a mount housing 48 cavity, a handle 47 to enable its at least partial rotation (that could be clockwise or anticlockwise irrespective of the considered rotation axis) within the mount housing 48 cavity around a first rotation axis 51A (shown as a double arrow 51B) and/or a second rotation axis 52A (shown as a double arrow 52B). Mount housing 48 may be fixed. The mount housing 48 cavity is substantially cylindrical and extends from a front aperture to a rear aperture (both not labelled here for the sake of clarity) along the direction of a mount housing axis 50A which is perpendicular to both front and rear faces. Front and rear apertures are located in front and rear faces, respectively. (The front and rear faces are partially shown in FIG. 7 but not labelled for the sake of clarity.) The image-bearing light emitted by microLED display panel first exits projector 42 via the exit aperture of projector 42, then leaves mount housing 48 cavity via front aperture to finally reach its target point located outside of the light engine mounting system (which is the centre of input region 55 of waveguide substrate 54). Handle 47 protrudes from rear aperture. Up to eight orifices 49 that extend through the mount housing 48 thickness to reach the mount housing 48 cavity are provided for the ingress of a locking fluid, such as an adhesive, which may be used to permanently fix adjustable mount body 45. The adhesive may also prevent ingress of debris or moisture, which are potentially detrimental to the operation of light-engine mounting system 41. The external walls of the curved portion 46 of adjustable mount body 45 fit into the internal walls of the mount housing 48 cavity so as to facilitate the at least partial rotation of adjustable mount body 45 within mount housing 48 cavity around first rotation axis 51A and/or second rotation axis 52A and/or mounting housing axis 50A. Additionally, it facilitates a limited translation of adjustable mount body 45 within the mount housing 48 cavity along the direction of mount housing axis 50A.

Mount housing axis 50A, first rotation axis 51A and second rotation axis 52A all intersect at a single point which is the centre of curved portion 46 of adjustable mount body 45. First rotation axis 51A relates to the pitch adjustment of the light engine mounting system while second rotation axis 52A to its yaw adjustment. Here, projector 42 is positioned relative to mount housing 48 such that mount housing axis 50A and the propagation direction of the image-bearing light are superimposed on each other: mount housing axis 50A acts as if it were a symmetry axis for projector 52. In other words, the image-bearing light emitted by projector 52 follows the direction of mount housing axis 50A. The image-bearing light is incident on the centre of input region 55 resulting in the monocular alignment of light-engine mounting system 41 with waveguide substrate 54. For the sake of clarity, the propagation direction of the image-bearing light is neither indicated nor labelled in FIG. 7. Partially rotating adjustable mount body 45 within mount housing 48 cavity around first rotation axis 51A and/or second rotation axis 52A allows for setting a propagation direction of the image-bearing light emitted by the projector (and thus the propagation direction of the image of the image-bearing light) that could be different to the direction of mount housing axis 50A, which offers some leeway to correct (to some extent) any monocular misalignment between the projector and the centre of input region 55. The clamping mechanism to reversibly lock adjustable rotatable projector mount 45 into a position may be the one described with reference to the first or second embodiment; it is however not depicted in FIG. 7 for the sake of clarity.

Additionally, adjustable mount body 45 can be translated to some extent within the cylindrical cavity of mount housing 48 along the direction of mount housing axis 50A: a double arrow 53 expresses the possibility for adjustable mount body 45 to move along the direction of mount housing axis 50A in both opposite ways, to have the image output by projector 52 in focus at the input region 55 of waveguide substrate 54. Handle 47 can also be used to perform limited translation of adjustable mount body 45 within the mount housing 48 cavity along the direction of mount housing axis 50A.

Furthermore, adjustable mount body 45 can at least partially rotate around mount housing axis 50A clockwise or anticlockwise as shown by a double arrow 50B to adjust the roll of the image. This at least partial rotation around mount housing axis 50A is implemented via handle 47.

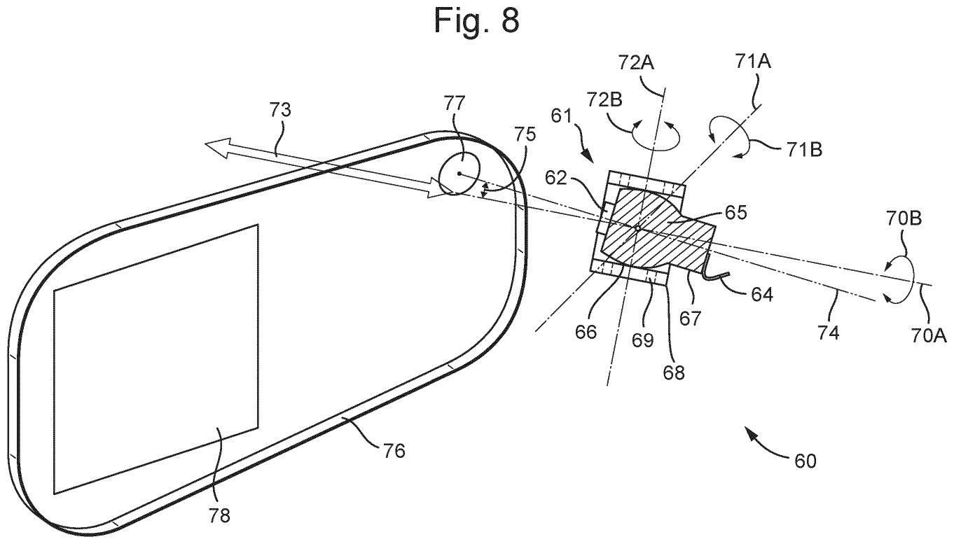

FIG. 8 shows an embodiment of an AR or VR display 60, more specifically a cross-sectional view of a light-engine mounting system 61 in accordance with the first or second embodiment of the present invention, monocularly aligned with a fixed waveguide combiner (by at least partially rotating the adjustable mount body within the mount housing cavity around the first rotation axis) to form an augmented reality display 60. (In FIG. 8, light-engine mounting system 61 is partially cross-sectioned so as to make the position of its adjustable mount body within its mount housing cavity clearly visible.)

The waveguide combiner comprises a single waveguide substrate 76 having an input region 77 and an output region 78. The waveguide combiner may comprise a plurality of waveguide substrates stacked together, each having input region and output regions.

The image-bearing light emitted by the projector held within the adjustable mount is steered towards the centre of the input region of the waveguide substrate so as to be coupled into the waveguide substrate. The image-bearing light then travels by total internal reflection within the waveguide substrate towards the output region, from where it is coupled out of the waveguide substrate via the output region towards an optical sensor (not shown here) that may be a camera or an eye of a viewer.

Light-engine mounting system 61 comprises a projector 62, an adjustable mount body 65 and a mount housing 68. Projector 62 comprises a microLED display panel—not shown here-(as image source) coupled to an electrical connector 64, and an internal optical assembly through which the image-bearing light is directed from the microLED display panel to the exit aperture of the projector. Adjustable mount body 65 comprises a cavity to receive projector 62, a curved portion 66 to facilitate its at least partial rotation within a mount housing 68 cavity, a handle 67 to enable its at least partial rotation (that could be clockwise or anticlockwise irrespective of the considered rotation axis) within mount housing 68 cavity around a first rotation axis 71A (shown as a double arrow 71B) and/or a second rotation axis 72A (shown as a double arrow 72B). Mount housing 68 may be fixed. The mount 68 cavity is substantially cylindrical and extends from a front aperture to a rear aperture (both not labelled here for the sake of clarity) along the direction of a mount housing axis 70A which is perpendicular to both front and rear apertures. Front and rear apertures are located in front and rear faces, respectively. (The front and rear faces are partially shown in FIG. 8 but not labelled for the sake of clarity.) The image-bearing light emitted by microLED display panel first exits projector 62 via the exit aperture of projector 62, then leaves mount housing 68 cavity via front aperture to finally reach its target point located outside of the light engine mounting system (which is initially a point of the perimeter of input region 77 of waveguide substrate 76, then the centre of input region 77 of waveguide substrate 76). Handle 27 protrudes from rear aperture. Up to eight orifices 69 that extend through the mount housing 68 thickness to reach the mount housing 68 cavity are provided for the ingress of a locking fluid, such as an adhesive, which may be used to permanently fix adjustable mount body 65. The adhesive may also prevent ingress of debris or moisture, which are potentially detrimental to the operation of light-engine mounting system 61. The external walls of the curved portion 66 of adjustable mount body 65 fit into the internal walls of the mount housing 68 cavity so as to facilitate the at least partial rotation of adjustable mount body 65 within mount housing 68 cavity around first rotation axis 71A and/or second rotation axis 72A and/or mounting housing axis 70A. Additionally, it facilitates a limited translation of adjustable mount body 65 within mount housing 68 cavity along the direction of mount housing axis 70A.

Mount housing axis 70A, first rotation axis 71A and second rotation axis 72A all intersect at a single point which is the centre of curved portion 66 of adjustable mount body 65. First rotation axis 71A relates to the pitch adjustment of the light engine mounting system while second rotation axis 72A to its yaw adjustment. At least partially rotating adjustable mount 65 within mount housing 68 cavity around first rotation axis 71A and/or second rotation axis 72A allows for setting a propagation direction of the image-bearing light emitted by projector 62 (and thus the propagation direction of the image of the image-bearing light) that could be different to the direction of mount housing axis 70A, which offers some leeway to correct (to some extent) any monocular misalignment between projector 62 and the centre of input region 77. Initially, projector 62 is monocularly misaligned with waveguide substrate 76: the image-bearing light emitted by projector 62 is steered towards the border of input region 77 as shown by extending mount housing axis 70A towards waveguide substrate 76. This monocular misalignment stems from the fact that mount housing 68 was not properly placed during manufacturing. By at least partially rotating adjustable mount body 65 within mount housing 68 cavity around first rotation axis 71A, projector 62 is positioned relative to mount housing 68 such that the resulting propagation direction 74 of the image-bearing light intersects the centre point of the input region of waveguide substrate 76 to achieve monocular alignment, resulting in having mount housing axis 70A and propagation direction 74 of the image-bearing light at an offset angle 75. Propagation direction 74 of the image-bearing light passes through the centre of curved portion 66 of adjustable mount body 65. Accordingly, adjustable mount body 65 allows for setting propagation direction 74 of the image-bearing light such that it differs from the direction of mount housing axis 70A up to a certain amount defined by the value of offset angle 75. The offset angle is dictated by the design of the light-engine mounting system. The available range of offset angles determines the available three-dimensional leeway to rectify a monocular misalignment between the projector and the fixed waveguide combiner. The clamping mechanism to reversibly lock adjustable mount body 65 into a position may be the one described with reference to the first or second embodiment; it is however not depicted in FIG. 8 for the sake of clarity.

Additionally, adjustable mount body 65 can be translated to some extent within the cylindrical cavity of mount housing 68 along the direction of mount housing axis 70A: a double arrow 73 expresses the possibility for adjustable mount body 65 to move along the direction of mount housing axis 70A in both opposite ways, to have the image output by projector 62 in focus at the input region of the waveguide substrate 76. Handle 67 can also be used to perform limited translation of adjustable mount body 65 within the mount housing 78 cavity along the direction of mount housing axis 70A.

Furthermore, adjustable mount body 65 can at least partially rotate around mount housing axis 70A clockwise or anticlockwise as shown by a double arrow 70B to adjust the roll of the image. This at least partial rotation around mount housing axis 70A is implemented via handle 67.

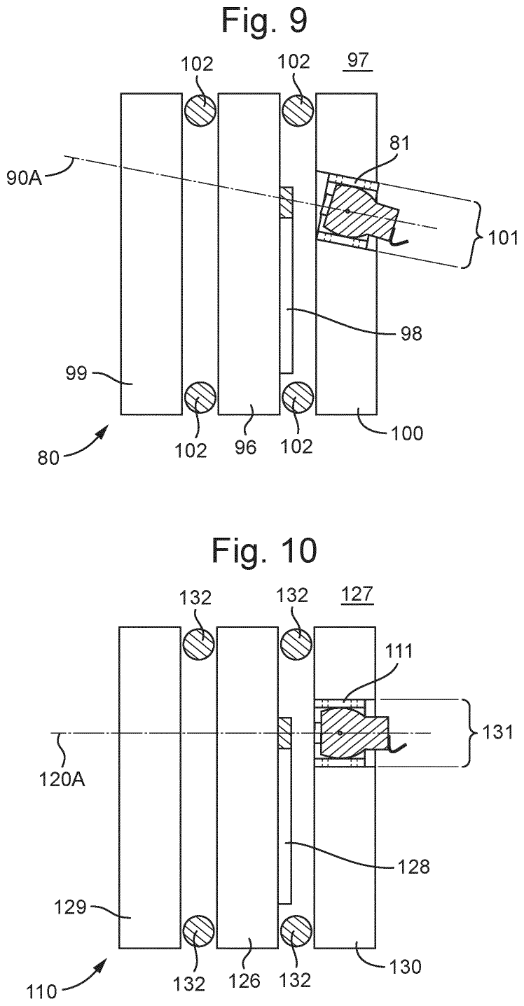

FIG. 9 represents an embodiment of an AR or VR display 80, more specifically a side view of cross-sectioned augmented reality display 80 comprising a fixed waveguide combiner and a light-engine mounting system 81 in accordance with the first or second embodiment of the present invention. (In FIG. 9, light-engine mounting system 81 is partially cross-sectioned so as to make the position of its adjustable mount body within its mount housing cavity clearly visible. For the sake of clarity with respect to FIG. 9, the components of light-engine mounting system 81 are not labelled and the possible movements of those components are neither shown nor labelled, and only the mount housing axis is visible and labelled.)

The immobilised waveguide combiner is made of a single waveguide substrate 96 having an input region 97 and an output region 98. The waveguide combiner may comprise a plurality of waveguide substrates. Waveguide substrate 96 is encapsulated between a front outer cover 99 and a rear outer cover 100 to protect it from any ingress that could affect its operation and spaced apart from the front 99 and rear 100 outer covers by spacers 102. The purpose of a gap between waveguide substrate 96 and rear and front outer covers 99, 100 (established by the presence of spacers 102) is to mitigate undesirable optical effects which otherwise might occur if there is no gap. Such effects could reduce image brightness or integrity.

Light-engine mounting system 81 may be inserted into a cavity 101 of rear outer cover 100 that extends through rear outer cover 100 along a direction neither parallel nor perpendicular to the waveguide plane of waveguide substrate 96. The mount housing of light-engine mounting system 81 is immobilised within cavity 101 and the direction of mount housing axis 90A is simply dictated by the direction along which cavity 101 extends. The cavity 101 shape may conform to the overall shape of light-engine mounting system 81 so as to allow for the placement of light-engine mounting system 81 within cavity 101. Here, the projector is positioned relative to the mount housing such that the mount housing axis and the propagation direction of the image-bearing light are superimposed on each other: the mount housing axis acts as if it were a symmetry axis for the projector. In other words, the image-bearing light emitted by the projector held within the light-engine mounting system follows the direction of the mount housing axis. For the sake of clarity, the propagation direction of the image-bearing light is neither indicated nor labelled in FIG. 9.

Mount housing axis 90A (and thus the propagation direction of the image-bearing light) intersects the centre point of input region 97 and the projector of light-engine mounting system 81 is appropriately monocularly aligned with waveguide substrate 96. The image-bearing light emitted by the projector held within the adjustable mount body is steered towards the centre of input region 97 of waveguide substrate 96 so as to be coupled into waveguide substrate 96. The image-bearing light then travels by total internal reflection within waveguide substrate 96 towards output region 98, from where it is coupled out of waveguide substrate 96 via output region 98 towards an optical sensor (not shown here) that may be a camera or an eye of a viewer.

If mount housing axis 90A were to not intersect the centre point of input region 97, the adjustable mount body of light-engine mounting system 81 could be at least partially rotated within the mount housing cavity around the first rotation axis and/or second rotation axis (via the handle of the adjustable mount body) to achieve a more desirable propagation direction of the image-bearing light, ensuring that it illuminates the centre point of input region 97.

Additionally, the adjustable mount body of light-engine mounting system 81 can be translated to some extent within the mount housing cavity along the direction of mount housing axis 90A in both opposite ways (via the handle of the adjustable mount body).

Furthermore, the adjustable mount body of light-engine mounting system 81 can at least partially rotate around its mount housing axis clockwise or anticlockwise to adjust the roll of the image. This at least partial rotation around mount housing axis 90A is implemented via the handle of the adjustable mount body.

FIG. 10 represents an embodiment of an AR or VR display 110, more specifically a side view of cross-sectioned augmented reality display 110 comprising a fixed waveguide combiner and a light-engine mounting system 111 in accordance with the first or second embodiment of the present invention. (In FIG. 10, light-engine mounting system 111 is partially cross-sectioned so as to make the position of its adjustable mount body within its mount housing cavity clearly visible. For the sake of clarity with respect to FIG. 10, the components of light-engine mounting system 111 are not labelled and the possible movements of those components are neither shown nor labelled, and only the mount housing axis is visible and labelled.)

The fixed waveguide combiner is made of a single waveguide substrate 126 having an input region 127 and an output region 128. The waveguide combiner may comprise a plurality of waveguide substrates. The waveguide substrate is encapsulated between a front outer cover 129 and a rear outer cover 130 to protect it from any ingress that could affect its operation and spaced apart from front 129 and rear 130 outer covers by spacers 132. The purpose of a gap between waveguide substrate 126 and rear and front outer covers 129, 130 (established by the presence of spacers 132) is to mitigate undesirable optical effects which otherwise might occur if there is no gap. Such effects could reduce image brightness or integrity.

Light-engine mounting system 111 may be inserted into a cavity 131 of rear outer cover 130 that extends through rear outer cover 130 along a direction perpendicular to the waveguide plane of waveguide substrate 126. The mount housing of light-engine mounting system 111 is fixed within cavity 131 and the direction of mount housing axis 120A is simply dictated by the direction along which cavity 131 extends. The cavity 131 shape may conform to the overall shape of light-engine mounting system 111 so as to allow for the placement of light-engine mounting system 111 within cavity 131. Here, the projector is positioned relative to the mount housing such that the mount housing axis and the propagation direction of the image-bearing light are superimposed on each other: the mount housing axis acts as if it were a symmetry axis for the projector. In other words, the image-bearing light emitted by the projector held within light-engine mounting system follows the direction of the mount housing axis. For the sake of clarity, the propagation direction of the image-bearing light is neither indicated nor labelled in FIG. 10.

Mount housing axis 120A (and thus the propagation direction of the image-bearing light) intersects the centre point of input region 127 and so the projector of light-engine mounting system 111 is appropriately monocularly aligned with waveguide substrate 126. The image-bearing light emitted by the projector held within the adjustable mount body is steered towards the centre of input region 127 of waveguide substrate 126 so as to be coupled into waveguide substrate 126. The image-bearing light then travels by total internal reflection within waveguide substrate 126 towards output region 128, from where it is coupled out of waveguide substrate 126 via output region 128 towards an optical sensor (not shown here) that may be a camera or an eye of a viewer.

If mount housing axis 120A were to not intersect the centre point of input region 127, the adjustable mount body of light-engine mounting system 111 could be at least partially rotated within the mount housing cavity around the first rotation axis and/or second rotation axis to achieve a more desirable propagation direction of the image-bearing light, ensuring that it illuminates the centre point of input region 127.

Additionally, the adjustable mount body of light-engine mounting system 111 can be translated to some extent within the mount housing cavity along the direction of mount housing axis 120A in both opposite ways (via the handle of the adjustable mount body).

Furthermore, the adjustable rotatable mount body of light-engine mounting system 111 can at least partially rotate around its mount housing axis clockwise or anticlockwise to adjust the roll of the image. This at least partial rotation around mount housing axis 120A is implemented via the handle of the adjustable rotatable projector mount.

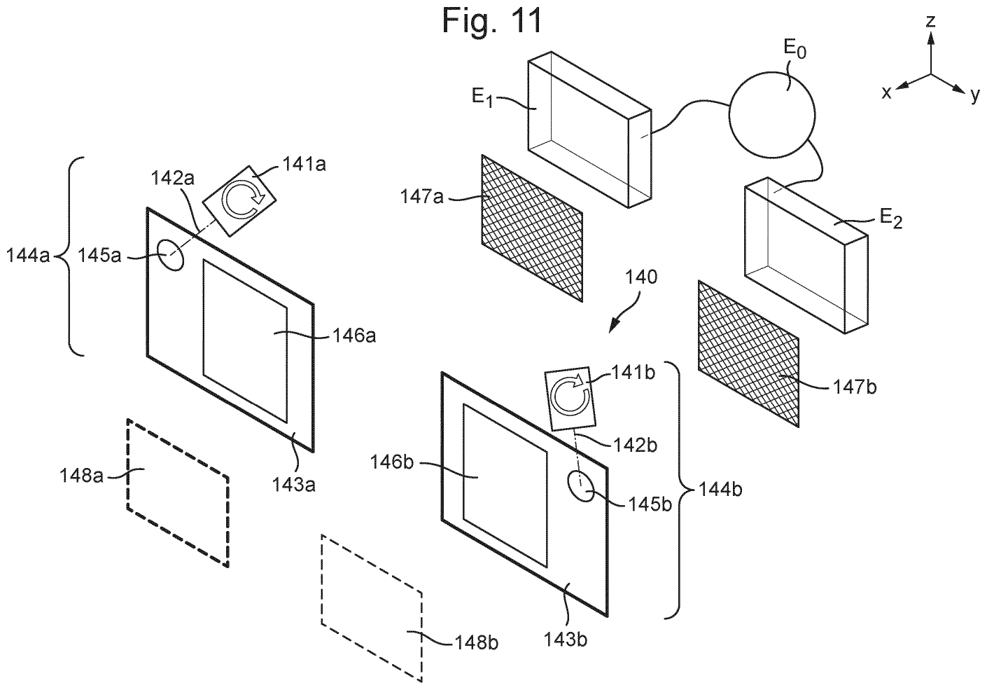

FIGS. 11 to 14 depict each an embodiment of an AR or VR display 140 comprising a left light-engine mounting system 141b/waveguide combiner 143b combination 144b and a right light-engine mounting system 141a/waveguide combiner 143a combination 144a. Each embodiment represents an exemplary apparatus for checking the binocular alignment of each light-engine mounting system/waveguide combiner combination 144a and 144b when arranged side by side, as for example in a pair of spectacles.

The exemplary apparatus for checking the binocular alignment of combinations 144a and 144b comprises a first optical sensor E1 and a second optical sensor E2, both connected to an image treatment system E0. When AR or VR display 140 is adjusted to achieve a given degree of binocular alignment between combination 144a and combination 144b (prior to the light-engine mounting systems 141a, 141b being fixed permanently using an adhesive as described herein above), each of first and second optical sensors E1, E2 may be a camera or other suitable sensor and image treatment system E0 may be a computer or other processing device programmed to process image data in such a way that it mimics the human brain. When AR or VR display 140 is to be used by a user (after having light-engine mounting systems 141a, 141b fixed permanently using an adhesive), each of first and second optical sensors E1, E2 may be the user's eyes and image treatment system E0 their brain.

Each light-engine mounting system 141a, 141b is in accordance with the first or second embodiments of the present invention, each of which may be arranged within respective cavities of a rear outer cover (not shown) such that their mount housing is immobilised and so their mount housing axis is fixed. When AR or VR display 140 is adjusted to achieve a given degree of binocular alignment between combination 144a and combination 144b, the projector of light-engine mounting systems 141a emits an image-bearing light which shares at least some same common virtual graphic information with the image-bearing light emitted by the projector of light-engine mounting system 141b so as to easily assess whether the desired degree of binocular alignment is achieved.

When AR or VR display 140 is to be used by a user, the projector of light-engine mounting systems 141a emits an image-bearing light which may share at least some same common virtual graphic information with the image-bearing light emitted by the projector of light-engine mounting system 141b or may share at least some related virtual graphic information exhibiting the same content from different viewing points in order for the user to perceive stereographic three-dimensional images, that tends to make augmented reality more immersive for users of such AR or VR displays.

Waveguide combiners 143a, 143b may be fixed within the frame (not shown) of AR or VR display 140 to become the right and left eyepieces. Each waveguide combiner 143a, 143b may comprise a single waveguide substrate (the reference numerals 123a, 123b can refer either to a waveguide combiner or a waveguide substrate) having an input region 145a, 145b and an output region 146a, 146b encapsulated in between a front outer cover and a rear outer cover (not shown here for the sake of clarity). Each waveguide combiner 143a, 143b may comprise a plurality of waveguide substrates.

The degree of binocular alignment desired will depend on the end result to be achieved. Achieving a given degree of binocular alignment between combination 144a and combination 144b (from no binocular alignment through partial binocular alignment to full binocular alignment) relies on the possibility for each light-engine mounting system 141a, 141b to modify the propagation direction of their respective image-bearing light, while preserving the monocular alignment of each combination 144a, 144b. Modifying the propagation direction of their respective image-bearing light incident on an input region of a waveguide combiner results in changing their propagation direction when coupled out of said waveguide combiner as an eyebox towards an optical sensor, and thus the position of the corresponding virtual image (perceived by the image treatment system) in the plane located at a given convergence distance from said optical sensor. However, modifying the propagation direction of their respective image-bearing light incident on an input region of a waveguide combiner shifts the target point of the image-bearing light on said input region. So long as the input region size is large enough to accommodate the entirety of the image-bearing light beam, monocular alignment of each image-bearing light/waveguide combiner combination is achieved. Consequently, it is possible to simultaneously achieve monocular alignment with respect to each combination 144a, 144b and binocular alignment between a pair of combinations 144a and 144b.

Each of FIGS. 11-14 corresponds to a given degree of binocular alignment achieved by setting the propagation direction of each image-bearing light emitted by light-engine mounting systems 141a, 141 thanks to their adjustable mount body, and will be described successively.

In FIG. 11, light-engine mounting system 141a and waveguide combiner 143a of combination 144a are monocularly aligned with each other: the propagation direction 142a of the image-bearing light emitted from the projector of light-engine mounting system 141a intersects the centre of input region 145a of waveguide combiner 143a. Similarly, light-engine mounting system 141b and waveguide combiner 143b of combination 144b are monocularly aligned with each other: the propagation direction 142b of the image-bearing light emitted by the projector of light-engine mounting system 141b intersects the centre of input region 145b of waveguide combiner 143b.

The image-bearing light emitted by the projector held within the adjustable mount body of light-engine mounting system 141a is steered towards the centre of input region 145a of waveguide substrate 143a so as to be coupled into waveguide substrate 143a. The image-bearing light then travels by total internal reflection within waveguide substrate 143a towards output region 146a, from where it is coupled out of waveguide substrate 143a. Similarly, the image-bearing light emitted by the projector held within the adjustable mount body of light-engine mounting system 141b is steered towards the centre of input region 145b of waveguide substrate 143b so as to be coupled into waveguide substrate 143b. The image-bearing light then travels by total internal reflection within waveguide substrate 143b towards output region 146b, from where it is coupled out of waveguide substrate 143b.

The image-bearing light emitted by the projector of light-engine mounting system 141a is output from waveguide combiner 143a across first eyebox 147a towards first optical sensor E1. The image-bearing light emitted by the projector of light-engine mounting system 141b is output from waveguide combiner 143b across a second eyebox 147b towards second optical sensor E2. Image treatment system E0 thus perceives first eyebox 147a (relayed by first optical sensor E1) as a virtual first image 148a located at a first convergence distance from first optical sensor E1. Image treatment system E0 perceives second eyebox 147b (relayed by second optical sensor E2) as a virtual second image 148b located at a second convergence distance from second optical sensor E2. The first and second convergence distances from first and second optical sensors E1, E2, respectively are configured to be substantially the same.

In FIG. 11, virtual first and second images 148a and 148b are perceived by image treatment system E0 as separated from each other: no binocular alignment is achieved, which is generally undesirable.

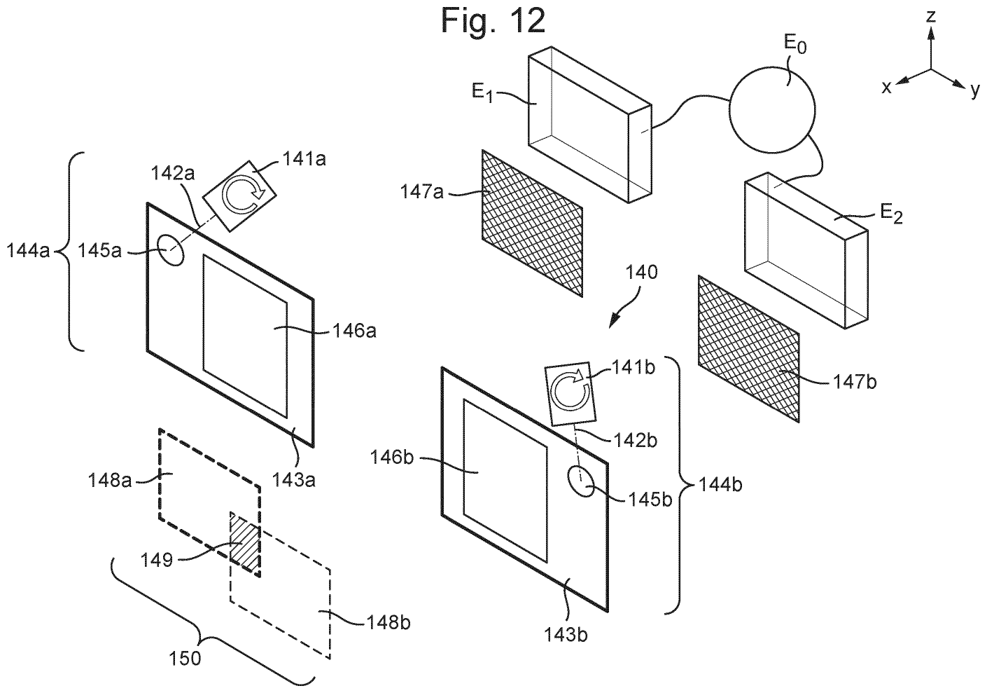

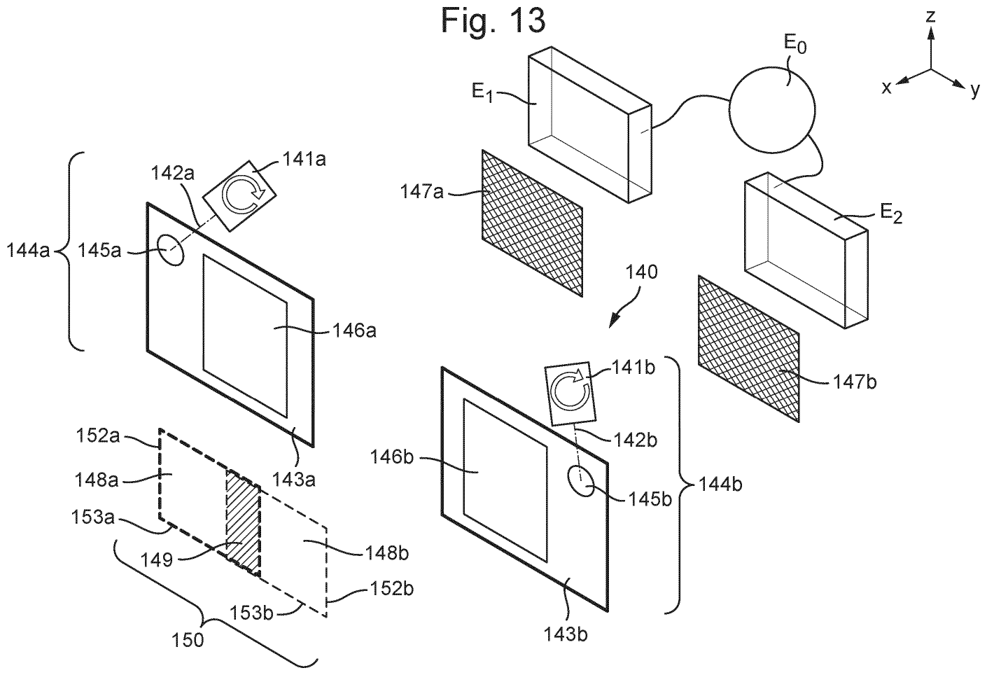

FIG. 12 comprises the same elements as FIG. 11 with the addition of other ones. FIG. 12 illustrates the case where virtual first and second images 148a, 148b perceived by image treatment system E0 at a same convergence distance from first and second optical sensors E1, E2, respectively, are partially overlapping (as shown by an overlap 149): virtual first and second images 148a, 148b are offset from one another both horizontally and vertically so as to form a combined image 150. The obtention of this partial binocular alignment between combination 144a and combination 144b both horizontally and vertically results from shifting the propagation direction 142a, 142b of each image-bearing light (emitted by the projectors of light-engine mounting systems 141a and 141b) using their respective adjustable mount body, respectively such that their propagation directions 142a, 142b allow for simultaneously achieving monocular alignment of each combination 144a, 144b and partial binocular alignment between combination 144a and combination 144b both horizontally and vertically. FIG. 13 illustrates a scenario where virtual first and second images 148a, 148b perceived by image treatment system E0 at a similar convergence distance from first and second optical sensors E1, E2, respectively, are partially overlapping as shown by an overlap 149: virtual first and second images 148a, 148b are offset from one another horizontally and aligned vertically with one another so as to form a combined image 150. The obtention of this partial binocular alignment between combination 144a and combination 144b results from shifting the propagation direction 142a, 142b of each image-bearing light (emitted by the projectors of light-engine mounting systems 141a and 141b using their respective adjustable mount body such that their propagation directions 142a, 142b allow for simultaneously achieving monocular alignment of each combination 144a, 144b and partial binocular alignment between combination 144a and combination 144b. In some other implementations (not shown here), virtual first and second images 148a, 148b are aligned horizontally but offset vertically so as to overlap to a certain degree. Their combined image would correspond to the combined image 150 of FIG. 13 rotated 90 degrees.

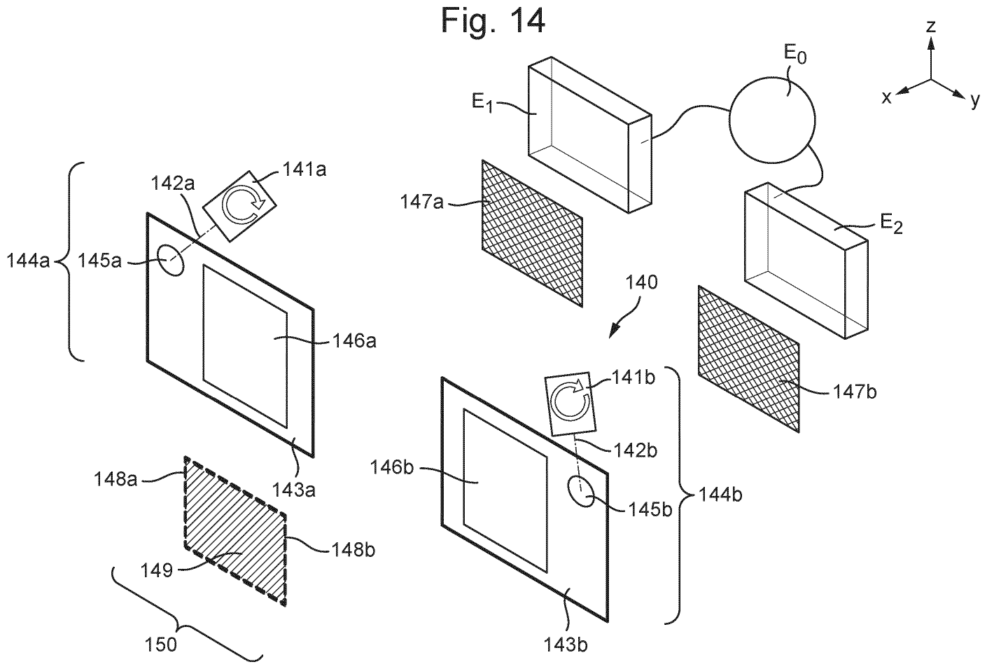

FIG. 14 illustrates a scenario where virtual first and second images 148a, 148b perceived by image treatment system E0 at a similar convergence distance from first and second optical sensors E1, E2, respectively, are fully overlapping (as shown by an overlap 149) and aligned horizontally and vertically with one another so as to form a combined image 150. The obtention of this full binocular alignment between combination 144a and combination 144b results from shifting the propagation direction 142a, 142b of each image-bearing light (emitted by the projectors of light-engine mounting systems 141a and 141b) using their respective adjustable mount body such that their propagation directions 142a, 142b allow for simultaneously achieving monocular alignment of each combination 144a, 144b and full binocular alignment between combination 144a and combination 144b.

During the adjustment process of AR or VR display 140 (for which FIGS. 11 to 14 may apply), virtual first and second images 148a, 148b are typically used in which the parts of the two images which are to overlap contain identical (common) image information, so that their alignment can be judged precisely. This could be checked by a human operator using image treatment system E0, or by appropriate image analysis configured to operate image treatment system E0. If less than the whole of each image is to overlap the other, virtual first and second images 148a, 148b used for the alignment process preferably each comprise a first part and a second part. The first part of each virtual image 148a, 148b is preferably the same in each of the two images and may contain appropriate markers to ease and check alignment, e.g. an image of crosshairs might be selected. The second part of each virtual image 148a, 148b is preferably distinct from the first part so that it is clear which parts are to be overlapped and which are not. Any virtual graphic information could be used in the second part of each image, and preferably this will also be different between virtual first and second images 148a, 148b.

During the adjustment process of AR or VR display 140, binocularly aligning the left and right light-engine mounting system/waveguide combiner combinations 144a, 144b relies on the use of cameras to improve the process in terms of quality of result and time taken to achieve alignment. The camera eyepieces emulate the user's eyes by collecting the virtual graphic information-bearing light output by each waveguide combiner as pixel-encoded images. Software is then used to assess the degree of binocular alignment of the left and right light-engine mounting system/waveguide combiner combinations 144a, 144b by comparing the positions of the pixel-encoded images.

During the use of AR or VR display 140 (for which FIGS. 11 to 14 may apply), the nature of the images projected for visualisation by a user (i.e. when the device is being used to display images) will depend on the desired effect to be achieved. For instance, when the image-bearing light emitted by the projector of light-engine mounting systems 141a is identical to the image-bearing light emitted by the projector of light-engine mounting system 141b, virtual first and second images 148a, 148b are identical. If the two images are fully overlapped (as in FIG. 14), the resulting combined image 150 will display the same virtual graphic information as those of each of the virtual first and second images 148a, 148b but its intensity will be higher than that of virtual first and second images. When the image-bearing light emitted by the projector of light-engine mounting system 141a and the image-bearing light emitted by the projector of light-engine mounting system 141b represent the same virtual graphic information but from different viewing points (e.g. different views of the same object or scene) and the images are fully overlapped, the combined image 150 will be a stereographic three-dimensional image. Three-dimensional images make AR more immersive for its users.

In other cases, when the image-bearing light emitted by the projector of light-engine mounting systems 141a and the image-bearing light emitted by the projector of light-engine mounting system 141b share a common portion of the virtual graphic information they carry while also displaying each a distinct portion of virtual graphic information and when said common portions of virtual first and second images 148a, 148b are overlapped on each other while the distinct portions are not (as in FIG. 12 or 13), image treatment system E0 is able to perceive an enlarged virtual field of view comprising the distinct portions of virtual first and second images 148a, 148b and their common portion i.e. overlap 149, the sum corresponding to combined image 150. Of course, it may be desirable for the overlapping portion to display a stereographic image in which case the image information provided by each virtual image in the overlapping portion may comprise images of the same scene or object from different viewing perspectives. For example, the overlapping part of the combined image may display a stereographic image of an object (e.g. a person) while the non-overlapping part(s) of the combined image may display two-dimensional text or other graphics, or the scenery surrounding the central region that is displayed to each eye.

The virtual first and second images 148a, 148b may or may not have the same shape as one another, e.g. rectangular or square. Their widths 152a, 152b and lengths 153a, 153b may or may not be substantially the same, respectively. Their widths and lengths are preferably oriented along the z-axis i.e. vertically and the y-axis i.e. horizontally, respectively. In FIGS. 13 and 14, the overlap 149 of virtual first and second images 148a, 148b occurs by aligning their widths and by translating virtual first and second images 148a, 148b along the y-axis i.e. horizontally.

The overlap 149 corresponds to the overlap of the common portion (of the virtual graphic information) of virtual first image 148a and the common portion (of the virtual graphic information) of virtual second image 148b. The overlap 149 is located between the distinct portion of virtual first image 148a and the distinct portion of virtual second image 148b. In preferred examples, at least 70% of each of virtual first and second images 148a, 148b may consist of the common virtual graphic information (that is to be superimposed). If the overlap is below 70%, it has been found that the user may experience discomfort and fatigue. However, this percentage is person-dependent. For instance, in some cases it may be preferable for at least 90% of each of virtual first and second images 148a, 148b to consist of the common virtual graphic information (that is to be superimposed). Said common portions are binocularly aligned while said distinct portions are not, which corresponds to a partial binocular alignment.

Full overlap of virtual first image 148a and virtual second image 148b corresponds to the user's minimum virtual field of view while partial overlap of virtual first image 148a and virtual second image 148b results in a virtual field of view greater than the minimum virtual field of view.

Additionally, in FIGS. 11 to 14, the adjustable mount body of each light-engine mounting system 141a, 141b can be translated to some extent within its respective mount housing cavity along the direction of its respective mount housing axis (in both opposite ways) so as to have its respective image output by its respective projector in focus at the input region of its respective waveguide substrate.

Furthermore, in FIGS. 11 to 14, the adjustable mount body of each light-engine mounting system 141a, 141b can at least partially rotate around the respective mount housing axis to adjust the roll of virtual first and second images 148a, 148b, respectively.

The invention may be further understood by reference to the following numbered clauses:
Clause 1. A light engine mounting system for an augmented reality or virtual reality display, comprising:
   a light engine housed within an adjustable mount body, the light engine being configured to project light along a first direction with respect to the adjustable mount body; and
   a mount housing having a mount housing axis, the mount housing comprising a cavity configured to receive the adjustable mount body and a first aperture through an exterior of the mount housing that opens into the cavity such that the light engine may project light through the mount housing via the first aperture, the first aperture being spaced from the cavity along the direction of the mount housing axis;
wherein the adjustable mount body and the cavity of the mount housing are shaped so as to enable the adjustable mount body to at least partially rotate within the cavity of the mount housing around at least a first rotation axis, such that the angle of the first direction may be changed with respect to the mount housing axis.
Clause 2. A light engine mounting system according to clause 1, wherein the adjustable mount body and the cavity of the mount housing are shaped so as to enable the adjustable mount body to at least partially rotate within the cavity of the mount housing around a second rotation axis such that the angle of the first direction may be changed with respect to the mount housing axis, the second rotation axis being different from the first rotation axis and preferably being perpendicular to the first rotation axis.
Clause 3. A light engine mounting system according to clause 1 or clause 2, wherein the mount housing cavity extends from the first aperture through the mount housing to a second aperture through an exterior of the mount housing, wherein preferably the cavity extends between the first and second apertures along the direction of the mount housing axis, and further preferably wherein the mount housing comprises a front face having the first aperture and a rear face having the second aperture, the front and rear faces preferably being parallel to each other, and the cavity extending along the direction normal to both the front and rear faces.
Clause 4. A light engine mounting system according to any of the preceding clauses, wherein the first rotation axis and, if provided, the second rotation axis are both perpendicular to the mount housing axis and the axes intersect at a single point within the mount housing.
Clause 5. A light engine mounting system according to any of the preceding clauses, wherein the adjustable mount body and the cavity of the mount housing are shaped so as to enable the adjustable mount body to at least partially rotate within the mount housing cavity around the mount housing axis.
Clause 6. A light engine mounting system according to any of the preceding clauses, wherein the adjustable mount body and the cavity of the mount housing are shaped so as to enable the adjustable mount body to be translatable within the mount housing cavity along the direction of the mount housing axis.
Clause 7. A light engine mounting system according to any preceding clauses, wherein the mount housing further comprises:
   a sidewall;
   a slot having a height and located in the sidewall such that the slot extends along the sidewall along the direction of the mount housing axis, the slot being in communication with the mount housing cavity; and
   an adjustable clamping mechanism to adjust the height of the slot, whereby adjustment of the height of the slot allows the adjustable mount body to be selectively clamped in position within the cavity.
Clause 8. A light engine mounting system according to clause 7, wherein the adjustable clamping mechanism comprises:
   a first hole through the sidewall of the mount housing along a direction other than parallel to the slot so as to have first and second portions of the first hole aligned and separated by the slot; and
   a shaft member extending through the first hole for engaging parts of the sidewall either side of the slot and urging said parts of the sidewall together so as to adjust the height of the slot.
Clause 9. A light engine mounting system according to clause 8, wherein the first and second portions of the first hole are non-threaded and threaded respectively;
   the shaft member, preferably being a partially-threaded screw, has first and second portions which are non-threaded and threaded, respectively, and having a first end, preferably a screw head, and a second end, preferably a screw tip, the first end being exposed and having an interface to enable its rotation; and
the first portion of the first hole receives the first shaft member portion and the second portion of the first hole receives at least a part of the second shaft member portion.
Clause 10. A light engine mounting system according to clause 7, wherein the adjustable clamping mechanism comprises:
   a band having an adjustable length, the band being placed around the mount housing axis such that adjustment of the length of the band adjusts the height of the slot.
Clause 11. A light engine mounting system according to clause 10, wherein the adjustable clamping mechanism comprises:
   the band having a length, a first end, a second end and a plurality of periodically-spaced grooves along the length of the band;
   a clamping device affixed to the band first end, comprising:
      a slit through which a portion of the band including the band second end passes; and
      a threaded shaft whose one end is exposed and having an interface to enable its rotation, the thread of the threaded shaft being engaged with a portion of the plurality of grooves of the band, whereby the rotation of the threaded shaft controls the extent of the portion of the band between the band first end and the slit.
Clause 12. A light engine mounting system according to any preceding clauses, wherein the adjustable mount body has one or more curved external walls, the one or more curved external walls engaging one or more internal walls of the mount housing defined by the mount housing cavity, the one or more curved external walls allowing the adjustable mount body to be at least partially rotated while maintaining engagement between the one or more curved external walls and the one or more internal walls, wherein preferably the adjustable mount body has a generally partially spherical portion defined by the one or more curved external walls.
Clause 13. A light engine mounting system according to any preceding clauses, wherein the mount housing cavity is substantially cylindrical.
Clause 14. A light engine mounting system according to at least clause 3, wherein the adjustable mount body further comprises an extended portion, said extended portion being arranged to extend through the second aperture, the extended portion being configured to be engaged to cause the adjustable mount body to at least partially rotate within the mount housing cavity around the or each rotation axis, and preferably to translate the adjustable mount body within the mount housing cavity along the direction of the mount housing axis.
Clause 15. A light engine mounting system according to any preceding clauses, wherein the mount housing further comprises at least one second hole, the second hole extending through the exterior of the mount housing and opening into the cavity such that the mount housing cavity is accessible via the at least one second hole, wherein the or each second hole is preferably arranged to allow the adjustable mount body to be permanently fixed in place in the cavity by means of an adhesive injected through said second hole.
Clause 16. An augmented reality or virtual reality display, comprising:
   a first light engine mounting system according to any preceding clauses configured to provide a first image-bearing light representing a first image;
   a frame; and
   a first waveguide combiner being fixed within the frame and comprising at least one waveguide substrate, the at least one waveguide substrate comprising a first input region and a first output region to couple the first image-bearing light into and out of the at least one waveguide substrate, respectively, the first input region having a perimeter;
wherein the adjustable mount body of the first light engine mounting system is able to at least partially rotate within the mount housing cavity around at least its first rotation axis in order to change where the first image-bearing light falls relative to the perimeter of the first input region of the at least one waveguide substrate, such that the first image-bearing light may be coupled into the at least one waveguide substrate, then steered towards the first output region and coupled out of the at least one waveguide substrate.
Clause 17. An augmented reality or virtual reality display according to clause 16, wherein the waveguide combiner further comprises rear and front outer covers to at least partially encapsulate the waveguide combiner, wherein the rear outer cover comprises a cavity configured to receive the mount housing, wherein the rear cover cavity and the mount housing are shaped such that insertion of mount housing into the rear outer cover cavity aligns the mount housing axis along a predetermined direction.
Clause 18. An augmented reality or virtual reality display according to clause 16 or 17, comprising:
   a second light engine mounting system according to any one of clauses 1 to 15, to provide a second image-bearing light, the second image-bearing light representing a second image, respectively;
   a second waveguide combiner being fixed in the frame and comprising at least one waveguide substrate, the at least one waveguide substrate of the second waveguide combiner having a second input region and a second output region to couple the second image-bearing light into and out of the at least one waveguide substrate of the second waveguide combiner, the second input region of the at least one waveguide substrate of the second waveguide combiner having a perimeter; and
      wherein the adjustable mount body of the second light engine mounting system is able to at least partially rotate within its respective mount housing cavity around at least its respective first rotation axis, in order to change where the second image-bearing light falls relative to the perimeter of the second input region of the at least one waveguide substrate of the second waveguide combiner, such that the second image-bearing light may be coupled into the at least one waveguide substrate of the second waveguide combiner, then steered towards the second output region of the at least one waveguide substrate of the second waveguide combiner and coupled out of the at least one waveguide substrate of the second waveguide combiner; wherein preferably the first and second images may be either substantially similar, or have substantially similar portions and substantially different portions.
Clause 19. A method for adjusting a light engine mounting system relative to a waveguide combiner comprising:
   1) providing a first light engine mounting system according to any one of clauses 1 to 15;
   2) providing a first waveguide combiner fixed within a frame, and comprising at least one waveguide substrate having a first input region and a first output region;
   3) actuating the light engine of the first light engine mounting system to emit a first image-bearing light; and
   4) at least partially rotating the adjustable mount body of the first light engine mounting system within the mount housing cavity around at least the first rotation axis to ensure that the first image-bearing light falls within the perimeter of the first input region of the at least one waveguide substrate so as to be coupled into the at least one waveguide substrate, then steered towards the first output region and coupled out of the at least one waveguide substrate.
Clause 20. A method according to clause 19, wherein in step 1) the first light engine mounting system is according to clause 6 or any one of clauses 7 to 15 when dependent on clause 6; in step 3) the first image-bearing light represents a first image and wherein step 4) further comprises translating the adjustable mount body within the mount housing cavity along the direction of the mount housing axis until the first image is in focus at the first input region.
Clause 21. A method for adjusting two light engine mounting systems and two waveguide combiners, comprising:
   1) providing first and second light engine mounting systems, each according to any one of clauses 1 to 15;
   2) providing a frame;
   3) providing first and second waveguide combiners, each being fixed within the frame and each comprising at least one waveguide substrate having input and output regions, the input regions of the at least one waveguide substrate of first and second waveguide combiners having each a perimeter;
   3) providing an image-treatment device comprising first and second optical sensors;
   4) actuating the light engine of first light engine mounting system to emit a first image-bearing light, the first image-bearing light representing a first image;
   5) actuating the light engine of second light engine mounting system to emit a second image-bearing light, the second image-bearing light representing a second image; and
   6) at least partially rotating the adjustable mount body of the first light engine mounting system within its respective mount housing cavity around at least its respective first rotation axis to ensure that the first image-bearing light falls within the perimeter of the input region of the at least one waveguide substrate of the first waveguide combiner so as to be coupled into said at least one waveguide substrate, then steered towards the output region of the at least one waveguide substrate of the first waveguide combiner and coupled out of said at least one waveguide substrate towards the first optical sensor, and/or at least partially rotating the adjustable mount body of the second light engine mounting system within its respective mount housing cavity around at least its respective first rotation axis to ensure that the second image-bearing light falls within the perimeter of the input region of the at least one waveguide substrate of the second waveguide combiner so as to be coupled into said at least one waveguide substrate, then steered towards the output region of the at least one waveguide substrate of the second waveguide combiner and coupled out of said at least one waveguide substrate towards the second optical sensor, such that the image-treatment device perceives the first and second images as positioned relative to one another on a same plane.
Clause 22. A method for adjusting two light engine mounting systems and two waveguide combiners according to clause 21, wherein in step 6) the at least partially rotating achieves at least partial, preferably full binocular alignment, such that the image-treatment device perceives the first and second images as at least partially, preferably fully, overlapping one another.
Clause 23. A method for adjusting two light engine mounting systems and two waveguide combiners according to clause 22, wherein at least a first part of the first image and at least a first part of a second image each comprise the same common virtual graphic information, and in step 6), the at least partially rotating is such that the image-treatment device perceives the first and second images to be positioned such that the first part of the first image and the first part of the second image overlap and are aligned with one another.
Clause 24. A method for adjusting two light engine mounting systems and two waveguide combiners according to clause 23, wherein at least a second part of the first image and at least a second part of the second image each comprise virtual graphic information which is different from the common virtual graphic information and preferably different from one another, and in step 6), the at least partially rotating is such that the image-treatment device perceives the first and second images to be positioned such that the second part of the first image does not overlap the second part of the second image.
Clause 25. A method for adjusting two light engine mounting systems and two waveguide combiners according to any one of clauses 21 to 24, wherein step 6) comprises further translating the adjustable mount body of each of the first and second light engine mounting systems within its respective mount housing cavity such that the first and second images are in focus at the input region of the at least one waveguide substrate of the first and second waveguide combiners, respectively.
Clause 26. A method according to any of clauses 19 to 25, wherein the or each light engine mounting system is according to clause 15, and further comprising, after at least partially rotating the adjustable mount body of the or each light engine mounting system, injecting an adhesive through the or each second hole in order to permanently fix the adjustable mount body in place in the cavity of the or each light engine mounting system.
Clause 27. A method of displaying images, comprising:
   1) providing a first light engine mounting system and a second light engine mounting system, each according to any one of clauses 1 to 15;
   2) providing a frame;
   3) providing first and second waveguide combiners, each being fixed in the frame and each having at least one waveguide substrate having input and output regions, the input regions of the first and second waveguide combiners having each a perimeter;
   4) actuating the light engine of the first light engine mounting system to emit a first image-bearing light representing a first image, such that the first image-bearing light is coupled into and out from the at least one waveguide substrate of the first waveguide combiner via the input and output regions of the at least one waveguide substrate of the first waveguide combiner, respectively towards a user; and
   5) actuating the light engine of the second light engine mounting system to emit a second image-bearing light representing a second image, such that the second image-bearing light is coupled into and out from the at least one waveguide substrate of the second waveguide combiner via the input and output regions of the at least one waveguide substrate of the second waveguide combiner, respectively towards a user;
wherein the adjustable mount body of each of the first and second light engine mounting systems is oriented within its respective mount housing cavity such that the first image-bearing light falls within the perimeter of the input region of the at least one waveguide substrate of the first waveguide combiner, the second image-bearing light falls within the perimeter of the input region of the at least one waveguide substrate of the second waveguide combiner and the user perceives the first and second images as positioned relative to one another on a same plane as at least partially, preferably fully, overlapping one another, whereby at least partial, preferably full, binocular alignment is achieved, respectively.
Clause 28. A method of displaying images according to clause 27, wherein at least a first part of the first image and at least a first part of the second image each comprise the same common virtual graphic information, and the adjustable mount body of each of the first and second light engine mounting systems is oriented within its respective mount housing cavity, such that the user perceives the first and second images to be positioned such that the first part of the first image and the first part of the second image overlap and are aligned with one another.
Clause 29. A method of displaying images according to clause 28, wherein at least a first part of the first image and at least a first part of the second image each comprise related virtual graphic information exhibiting the same content from different viewing points, and the adjustable mount body of each of the first and second light engine mounting systems is oriented within its respective mount housing cavity, such that the user perceives the first and second images to be positioned such that the first part of the first image and the first part of the second image overlap and are aligned with one another, and appear as a stereographic three-dimensional image.
Clause 30. A method of displaying images according to any one of clauses 28 and 29, wherein at least a second part of the first image and at least a second part of the second image each comprise virtual graphic information which is different from that in the respective first parts and preferably from one another, and the adjustable mount body of each of the first and second light engine mounting systems is oriented within its respective mount housing cavity such that the user perceives the first and second images to be positioned such that the second part of the first image does not overlap the second part of the second image.
Clause 31. A method of displaying images according to any one of clauses 27 to 30, wherein the adjustable mount body of each of the first and second light engine mounting systems is placed within its respective mount housing cavity such that the first and second images are in focus at the input region of the at least one waveguide substrate of the first and second waveguide combiners, respectively.

1. A light engine mounting system for an augmented reality or virtual reality display, comprising:
a light engine housed within an adjustable mount body to project light along a first direction with respect to the adjustable mount body; and
a mount housing having a mount housing axis, the mount housing comprising a cavity configured to receive the adjustable mount body and a first aperture through an exterior of the mount housing that opens into the cavity such that the light engine may project light through the mount housing via the first aperture, the first aperture being spaced from the cavity along the direction of the mount housing axis;
the adjustable mount body and the cavity of the mount housing being shaped to enable the adjustable mount body to at least partially rotate within the cavity of the mount housing around at least a first rotation axis, such that an angle of the first direction can be changed with respect to the mount housing axis.

2. The light engine mounting system of claim 1, wherein the adjustable mount body and the cavity of the mount housing are shaped to enable the adjustable mount body to at least partially rotate within the cavity of the mount housing around a second rotation axis such that the angle of the first direction can be changed with respect to the mount housing axis, the second rotation axis being different from the first rotation.

3. The light engine mounting system of claim 1, wherein the first rotation axis is perpendicular to the mount housing axis and intersects the mount housing axis at a single point within the mount housing.

4. The light engine mounting system of claim 1, wherein the adjustable mount body and the cavity of the mount housing are shaped so as to enable the adjustable mount body to at least partially rotate within the mount housing cavity around the mount housing axis.

5. The light engine mounting system of claim 1, wherein the adjustable mount body and the cavity of the mount housing are shaped to enable the adjustable mount body to be translatable within the mount housing cavity along the direction of the mount housing axis.

6. The light engine mounting system of claim 1, wherein the mount housing further comprises:
a sidewall;
a slot having a height and located in the sidewall such that the slot extends along the sidewall along the direction of the mount housing axis, the slot being in communication with the mount housing cavity; and
an adjustable clamping mechanism to adjust the height of the slot, whereby adjustment of the height of the slot allows the adjustable mount body to be selectively clamped in position within the cavity.

7. A light engine mounting system according to claim 6, wherein the adjustable clamping mechanism comprises:
a first hole through the sidewall of the mount housing along a direction other than parallel to the slot such that first and second portions of the first hole are aligned and separated by the slot; and
a shaft member extending through the first hole for engaging parts of the sidewall either side of the slot and urging said parts of the sidewall together to adjust the height of the slot.

8. A light engine mounting system according to claim 7, wherein the first and second portions of the first hole are non-threaded and threaded respectively;
the shaft member has first and second portions which are non-threaded and threaded, respectively, and having a first end and a second end the first end being exposed and having an interface to enable its rotation; and
the first portion of the first hole receives the first shaft member portion and the second portion of the first hole receives at least a part of the second shaft member portion.

9. The light engine mounting system of claim 1, wherein the adjustable mount body has one or more curved external walls, the one or more curved external walls engaging one or more internal walls of the mount housing defined by the mount housing cavity, the one or more curved external walls allowing the adjustable mount body to be at least partially rotated while maintaining engagement between the one or more curved external walls and the one or more internal walls.

10. The light engine mounting system of claim 1, wherein the mount housing further comprises at least one second hole, the second hole extending through the exterior of the mount housing and opening into the cavity such that the mount housing cavity is accessible via the at least one second hole.

11. An augmented reality or virtual reality display, comprising:
a first light engine mounting system configured to provide a first image-bearing light representing a first image, the first light engine mounting system comprising:
a light engine housed within an adjustable mount body to project the first image-bearing light along a first direction with respect to the adjustable mount body; and
a mount housing having a mount housing axis, the mount housing comprising a cavity configured to receive the adjustable mount body and a first aperture through an exterior of the mount housing that opens into the cavity such that the light engine may project the first image-bearing light through the mount housing via the first aperture, the first aperture being spaced from the cavity along the direction of the mount housing axis;
the adjustable mount body and the cavity of the mount housing being shaped to enable the adjustable mount body to at least partially rotate within the cavity of the mount housing around at least a first rotation axis, such that an angle of the first direction can be changed with respect to the mount housing axis;
a frame; and
a first waveguide combiner being fixed within the frame and comprising at least one waveguide substrate, the at least one waveguide substrate comprising a first input region and a first output region to couple the first image-bearing light into and out of the at least one waveguide substrate, respectively, the first input region having a perimeter;
the adjustable mount body of the first light engine mounting system being able to at least partially rotate within the mount housing cavity around at least the first rotation axis in order to change where the first image-bearing light falls relative to the perimeter of the first input region of the at least one waveguide substrate, such that the first image-bearing light may be coupled into the at least one waveguide substrate, then steered towards the first output region and coupled out of the at least one waveguide substrate.

12. An augmented reality or virtual reality display according to claim 11, comprising:
a second light engine mounting system to provide a second image-bearing light, the second image-bearing light representing a second image; and
a second waveguide combiner being fixed in the frame and comprising at least one waveguide substrate, the at least one waveguide substrate of the second waveguide combiner having a second input region and a second output region to couple the second image-bearing light into and out of the at least one waveguide substrate of the second waveguide combiner, the second input region of the at least one waveguide substrate of the second waveguide combiner having a perimeter;
wherein an adjustable mount body of the second light engine mounting system is able to at least partially rotate within a respective mount housing cavity around at least a respective first rotation axis, in order to change where the second image-bearing light falls relative to the perimeter of the second input region of the at least one waveguide substrate of the second waveguide combiner, such that the second image-bearing light may be coupled into the at least one waveguide substrate of the second waveguide combiner, then steered towards the second output region of the at least one waveguide substrate of the second waveguide combiner and coupled out of the at least one waveguide substrate of the second waveguide combiner.

13. A method for adjusting two light engine mounting systems and two waveguide combiners, comprising:
providing first and second light engine mounting systems, each according to claim 1;
providing a frame;
providing first and second waveguide combiners, each being fixed within the frame and each comprising at least one waveguide substrate having input and output regions, the input regions of the at least one waveguide substrate of first and second waveguide combiners having each a perimeter;
providing an image-treatment device comprising first and second optical sensors;
actuating the light engine of first light engine mounting system to emit a first image-bearing light, the first image-bearing light representing a first image;
actuating the light engine of second light engine mounting system to emit a second image-bearing light, the second image-bearing light representing a second image;
at least partially rotating the adjustable mount body of the first light engine mounting system within its respective mount housing cavity around at least its respective first rotation axis to ensure that the first image-bearing light falls within the perimeter of the input region of the at least one waveguide substrate of the first waveguide combiner such that the first image-bearing light is coupled into said at least one waveguide substrate, then steered towards the output region of the at least one waveguide substrate of the first waveguide combiner and coupled out of said at least one waveguide substrate towards the first optical sensor; and
at least partially rotating the adjustable mount body of the second light engine mounting system within its respective mount housing cavity around at least its respective first rotation axis to ensure that the second image-bearing light falls within the perimeter of the input region of the at least one waveguide substrate of the second waveguide combiner so as to be such that the second image-bearing light is coupled into said at least one waveguide substrate, then steered towards the output region of the at least one waveguide substrate of the second waveguide combiner and coupled out of said at least one waveguide substrate towards the second optical sensor;
such that the image-treatment device detects the first and second images as positioned relative to one another on a same plane.

14. A method for adjusting two light engine mounting systems and two waveguide combiners according to claim 13, wherein the at least partially rotating of the adjustable mount body of the first light engine mounting system achieves at least partial binocular alignment, such that the image-treatment device perceives the first and second images as at least partially overlapping one another.

15. A method for adjusting two light engine mounting systems and two waveguide combiners according to claim 14, wherein at least a first part of the first image and at least a first part of a second image each comprise identical common virtual graphic information, and wherein the at least partially rotating of the adjustable mount body of the first light engine mounting system is such that the image-treatment device perceives the first and second images to be positioned such that the first part of the first image and the first part of the second image overlap and are aligned with one another.
